(19) United States
(12) Patent Application Publication
(10) Pub. No.: US 2026/0081719 A1
(43) Pub. Date: Mar. 19, 2026

(54) METHODS, SYSTEMS, AND APPARATUS FOR PARTIAL CODE RATE REDUCTION IN POLAR CODING

(71) Applicant: Huawei Technologies Co., Ltd., Shenzhen (CN)

(72) Inventors: Huazi Zhang, Hangzhou (CN); Jun Wang, Hangzhou (CN); Wen Tong, Ottawa (CA); Yiqun Ge, Ottawa (CA)

(21) Appl. No.: 19/336,287

(22) Filed: Sep. 22, 2025

Related U.S. Application Data
(63) Continuation of application No. PCT/CN2023/092465, filed on May 6, 2023.
(60) Provisional application No. 63/454,066, filed on Mar. 23, 2023.

(51) Int. Cl. H04L 1/00

(52) U.S. Cl. CPC H04L 1/0057; H04L 1/0002; H04L 1/0067

(57) ABSTRACT

Polar codes for wireless communications are constructed to adapt to channel conditions. The polar code construction includes a partial code rate reduction. Input bits are encoded by a polar code to obtain a number of encoded bits, and the number of the encoded bits on bit indices in a first segment of encoded bit indices of the encoded bits is reduced. The polar code includes or provides a first set of bit indices for values of the input bits, a second set of bit indices for a predetermined bit value, and a third set of bit indices corresponding to the first segment of encoded bit indices. The second set and the third set of bit indices include a first bit index on which the predetermined bit value is placed to reduce a code rate of the first segment.

### CROSS-REFERENCE TO RELATED APPLICATIONS

The present application is a continuation of International Application No. PCT/CN2023/092465, entitled “METHODS, SYSTEMS, AND APPARATUS FOR PARTIAL CODE RATE REDUCTION IN POLAR CODING” and filed on May 6, 2023, and claims the benefit of U.S. provisional patent application Ser. No. 63/454,066, entitled “Methods, Systems, and Apparatus for Partial Code Rate Reduction in Polar Coding”, filed on Mar. 23, 2023, which is hereby incorporated by reference in its entirety.

The present application is also related to the following Patent Cooperation Treaty (PCT) applications by the same applicant:
PCT Application No. PCT/CN2023/083350, entitled “Methods, Systems, and Apparatus for Non-Sequential Decoding of Polar Codes”, filed on Mar. 23, 2023;
PCT Application No. PCT/CN2023/083348, entitled “Methods, Systems, and Apparatus for Bit Value Placement in Polar Coding”, filed on Mar. 23, 2023;
PCT Application No. PCT/CN2023/083345, entitled “Methods, Systems, and Apparatus for Encoded Bit Reduction in Polar Coding”, filed on Mar. 23, 2023; and
PCT Application No. PCT/CN2023/083352, entitled “Methods, Systems, and Apparatus for Protograph-based Low Density Parity Check Coding”, filed on Mar. 23, 2023,
and is related to the following United States provisional patent applications as well:
U.S. provisional patent application Ser. No. 63/454,067, entitled “Methods, Systems, and Apparatus for Rateless Polar Coding”, filed on Mar. 23, 2023;
U.S. provisional patent application Ser. No. 63/454,068, entitled “Methods, Systems, and Apparatus for Rateless Polar Coding and Low-complexity Decoding”, filed on Mar. 23, 2023;
U.S. provisional patent application Ser. No. 63/454,069, entitled “Methods, Systems, and Apparatus for Rateless Polar Coding and Incremental Redundancy”, filed on Mar. 23, 2023; and
U.S. provisional patent application Ser. No. 63/454,070, entitled “Methods, Systems, and Apparatus for Channel-dependent Error Correction Coding”, filed on Mar. 23, 2023. The disclosures of the aforementioned applications are hereby incorporated by reference in their entireties.

### TECHNICAL FIELD

The present application relates to coding, and in particular to code rate reduction in polar coding.

### BACKGROUND

In wireless communications, channel conditions are constantly changing at both fast and slow scale due to, for example, fading effects. Accordingly, channel coding has conventionally always been designed to adapt to channel conditions. Modulation coding scheme (MCS) adaptation, in which the modulation order and code length and code rate can be changed in real time, is a powerful approach to combat varying channel conditions.

Adapting to channel conditions requires channel coding that can flexibly change code length and code rate in a fine-grained way, and at the same time achieve good error correction performance in all possible configurations. This fine-grained flexibility of channel codes remains a challenge.

Probabilistic codes such as low density parity check (LDPC) codes, which are more like random codes, may be naturally suited for flexibility. However, algebraic codes such as Reed-Muller (RM) codes and Bose-Chaudhuri-Hocquenghem (BCH) codes, are not as flexible as probabilistic codes. This is because their inherent coding structures may be compromised when code length or rate changes. Polar codes exhibit features from both probabilistic codes and algebraic codes. As a result, polar codes have a level of flexibility that lies between probabilistic codes and algebraic codes.

Rate matching, including techniques such as puncturing and shortening, are available to design rate-compatible polar codes, such as the polar codes for fifth generation (5G) new radio (NR). However, the degree of flexibility is not enough to support more advanced features such as fine-grained incremental-redundancy hybrid automatic repeat request (IR-HARQ), for example.

A more flexible channel coding approach is needed.

### SUMMARY

The present disclosure encompasses embodiments related to what is referred to herein primarily as partial code rate reduction, to allocate information bits. Adaptive partial code rate reduction and piece-wise partial code rate reduction to allocate information bits are also disclosed to allocate information bits. An “implicit” reliability sequence-based approach is proposed as well. Embodiments of the present disclosure may address or mitigate problems related to providing low-complexity puncture-only rate matching for polar codes. For example, embodiments may help reduce code construction latency.

According to an aspect of the present disclosure, a method involves encoding input bits, reducing a number of the encoded bits, and outputting the reduced number of the encoded bits. The encoding involves encoding the input bits by a polar code to obtain a number of encoded bits. The polar code comprises bit indices for placing values of the input bits before encoding. The bit indices comprise: a first set of bit indices for the values of the input bits, a second set of bit indices for a predetermined bit value, and a third set of bit indices corresponding to a first segment of multiple unique segments of encoded bit indices of the encoded bits. Each segment of the encoded bit indices includes fewer than all encoded bit indices of all of the encoded bits. The second set and the third set of bit indices include a first bit index on which the predetermined bit value is placed to reduce a code rate of the first segment of the encoded bit indices. The reducing involves a number of the encoded bits on the bit indices in the first segment of the encoded bit indices of the encoded bits.

Another method involves obtaining an ordered sequence indicating a plurality of bit indices for a polar code in an order of rank for placing values of input bits for encoding by the polar code to obtain a number of encoded bits, encoding the input bits by the polar code according to the ordered sequence, to obtain the number of encoded bits, reducing a number of the encoded bits on bit indices in a first segment of encoded bit indices of the encoded bits, and outputting the reduced number of the encoded bits. The bit indices comprise: a first set of bit indices of highest rank according to the ordered sequence, for placing the values of the input bits; a second set of bit indices of lower rank than the highest rank according to the ordered sequence, for a predetermined bit value; and a third set of bit indices corresponding to the first segment of the encoded bit indices of the encoded bits. The order of rank is for reducing the number of the encoded bits. The second set and the third set of bit indices include a first bit index on which the predetermined bit value is to be placed to reduce a code rate of the first segment of the encoded bit indices. The first segment is one segment of multiple unique segments of encoded bit indices of the encoded bits. Each segment of the encoded bit indices includes fewer than all of the encoded bit indices of all of the encoded bits.

A method according to another aspect of the present disclosure involves receiving a reduced number of encoded bits encoded by a polar code. The polar code comprises bit indices for placing values of input bits, and the bit indices comprise: a first set of bit indices for the values of the input bits, a second set of bit indices for a predetermined bit value, and a third set of bit indices corresponding to a first segment of a plurality of unique segments of encoded bit indices of the encoded bits. Each segment of the encoded bit indices includes fewer than all encoded bit indices of all of the encoded bits. The second set and the third set of bit indices include a first bit index on which the predetermined bit value is placed to reduce a code rate of the first segment of the encoded bit indices. Such a method may also involve decoding the reduced number of encoded bits to obtain decoded input bits.

The present disclosure also encompasses a method that involves receiving a reduced number of encoded bits encoded by a polar code, and decoding the reduced number of encoded bits to obtain decoded input bits. The polar code comprises bit indices for placing values of input bits, and the bit indices comprise: a first set of bit indices of highest rank according to an ordered sequence, for placing the values of the input bits before encoding; a second set of bit indices of lower rank than the highest rank according to the ordered sequence, for a predetermined bit value; and a third set of bit indices corresponding to a first segment of encoded bit indices of the encoded bits. The order of rank is for reducing the number of the encoded bits. The second set and the third set of bit indices include a first bit index on which the predetermined bit value is to be placed to reduce a code rate of the first segment of the encoded bit indices. The first segment is one segment of multiple unique segments of encoded bit indices of the encoded bits, and each segment of the encoded bit indices includes fewer than all of the encoded bit indices of all of the encoded bits.

Apparatus embodiments are also disclosed.

An apparatus may include an encoder, a rate matching module, and an interface. The encoder is for encoding input bits by a polar code to obtain a number of encoded bits. The polar code comprises bit indices for placing values of the input bits before encoding, and the bit indices comprise: a first set of bit indices for the values of the input bits, a second set of bit indices for a predetermined bit value, and a third set of bit indices corresponding to a first segment of multiple unique segments of encoded bit indices of the encoded bits. Each segment of the encoded bit indices includes fewer than all encoded bit indices of all of the encoded bits. The second set and the third set of bit indices include a first bit index on which the predetermined bit value is placed to reduce a code rate of the first segment of the encoded bit indices. The rate matching module is coupled to the encoder, for reducing a number of the encoded bits on the bit indices in the first segment of the encoded bit indices of the encoded bits. The interface is coupled to the rate matching module, for outputting the reduced number of the encoded bits.

Another apparatus embodiment also includes an encoder, a rate matching module, and an interface, and the encoder is for obtaining an ordered sequence and encoding input bits by a polar code according to the ordered sequence, to obtain a number of encoded bits. The rate matching module is coupled to the encoder, for reducing a number of the encoded bits on bit indices in a first segment of the encoded bit indices of the encoded bits, and the interface is coupled to the rate matching module, for outputting the reduced number of the encoded bits. The ordered sequence indicates bit indices for the polar code in an order of rank for placing values of the input bits for encoding by the polar code, the bit indices comprising: a first set of bit indices of highest rank according to the ordered sequence, for placing the values of the input bits; a second set of bit indices of lower rank than the highest rank according to the ordered sequence, for a predetermined bit value; and a third set of bit indices corresponding to the first segment of encoded bit indices of the encoded bits. The order of rank is for reducing the number of the encoded bits. The second set and the third set of bit indices include a first bit index on which the predetermined bit value is to be placed to reduce a code rate of the first segment of the encoded bit indices. The first segment is one segment of multiple unique segments of encoded bit indices of the encoded bits, and each segment of the encoded bit indices includes fewer than all of the encoded bit indices of all of the encoded bits.

An apparatus may include an interface and a decoder. The interface is for receiving a reduced number of encoded bits encoded by a polar code, and the decoder is coupled to the interface, for decoding the reduced number of encoded bits to obtain decoded input bits. The polar code comprises bit indices for placing values of input bits, and the bit indices comprise: a first set of bit indices for the values of the input bits, a second set of bit indices for a predetermined bit value, and a third set of bit indices corresponding to a first segment of multiple unique segments of encoded bit indices of the encoded bits. Each segment of the encoded bit indices includes fewer than all encoded bit indices of all of the encoded bits. The second set and the third set of bit indices include a first bit index on which the predetermined bit value is placed to reduce a code rate of the first segment of the encoded bit indices.

According to another apparatus embodiment, an apparatus includes an interface for receiving a reduced number of encoded bits encoded by a polar code and a decoder coupled to the interface for decoding the reduced number of encoded bits to obtain decoded input bits, and the polar code comprises bit indices for placing values of input bits. The bit indices comprise: a first set of bit indices of highest rank according to an ordered sequence, for placing the values of the input bits before encoding; a second set of bit indices of lower rank than the highest rank according to the ordered sequence, for a predetermined bit value; and a third set of bit indices corresponding to a first segment of encoded bit indices of the encoded bits. The order of rank for reducing the number of the encoded bits. The second set and the third set of bit indices include a first bit index on which the predetermined bit value is to be placed to reduce a code rate of the first segment of the encoded bit indices. The first segment is one segment of multiple unique segments of encoded bit indices of the encoded bits, and each segment of the encoded bit indices includes fewer than all of the encoded bit indices of all of the encoded bits.

In other apparatus embodiments, an apparatus may include a processor configured to cause the apparatus to perform a method as disclosed herein.

An apparatus may include a processor and a non-transitory computer readable storage medium that is coupled to the processor. The non-transitory computer readable storage medium stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

A system is also disclosed, and may include a first communication device and a second communication device. The first communication device is configured to encode input bits by a polar code to obtain a number of encoded bits, to reduce a number of the encoded bits on bit indices in a first segment of encoded bit indices of the encoded bits, and to transmit the reduced number of encoded bits. The polar code comprises bit indices for placing values of the input bits before encoding, and the bit indices comprise: a first set of bit indices for the values of the input bits, a second set of bit indices for a predetermined bit value, and a third set of bit indices corresponding to the first segment. The first segment is one segment of multiple unique segments of the encoded bit indices of the encoded bits. Each segment of the encoded bit indices includes fewer than all encoded bit indices of all of the encoded bits. The second set and the third set of bit indices comprise a first bit index on which the predetermined bit value is placed to reduce a code rate of the first segment of the encoded bit indices. The second communication device is configured to receive the reduced number of the encoded bits from the first communication device, and to decode the reduced number of the encoded bits to obtain decoded input bits.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a trellis graph illustrating an example of a polar code.

FIG. 6 is a diagram illustrating puncturing and shortening with a cyclic buffer.

FIG. 7 is a diagram illustrating partial code rate reduction according to an embodiment.

FIG. 8 is a diagram illustrating partial code rate reduction according to another embodiment.

FIG. 9 is a diagram illustrating piece-wise partial code rate reduction according to a further embodiment.

FIG. 10 is a diagram illustrating piece-wise partial code rate reduction according to yet another embodiment.

FIG. 11 includes trellis graphs illustrating partial code rate reduction according to an embodiment.

FIG. 12 includes trellis graphs illustrating partial code rate reduction according to another embodiment.

FIG. 13 includes trellis graphs illustrating partial code rate reduction according to a further embodiment.

FIG. 14 includes trellis graphs illustrating partial code rate reduction according to yet another embodiment.

FIG. 15 is a flow diagram illustrating more general example methods according to embodiments.

FIG. 16 is a block diagram illustrating an apparatus according to an embodiment.

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

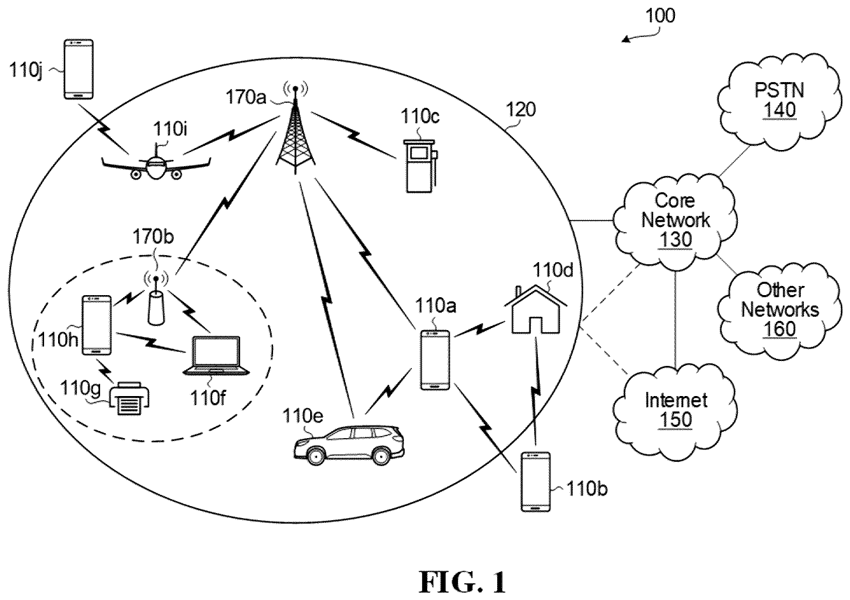

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

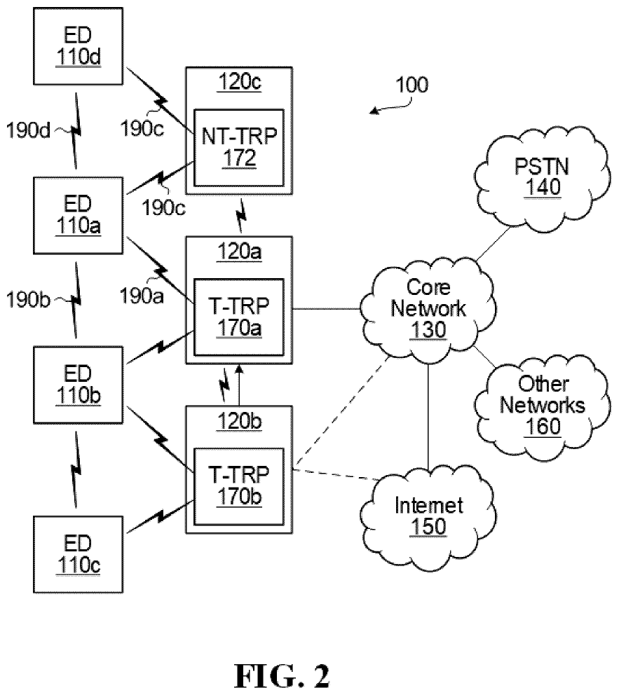

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

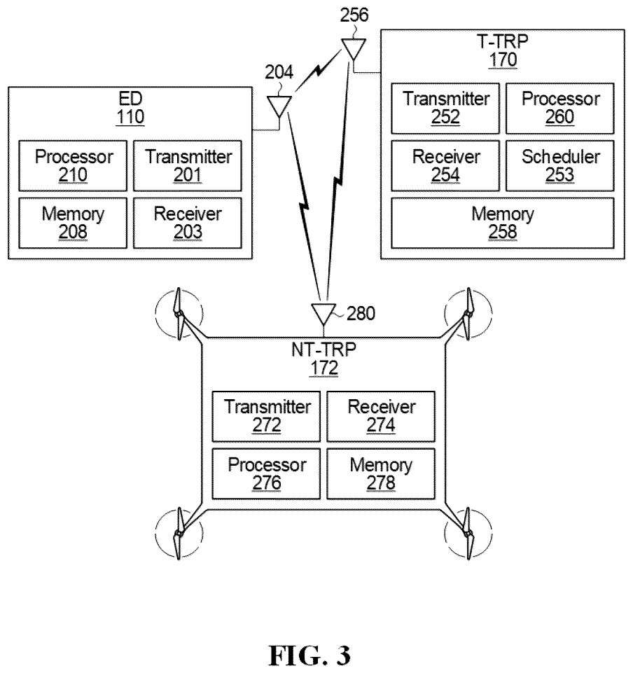

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

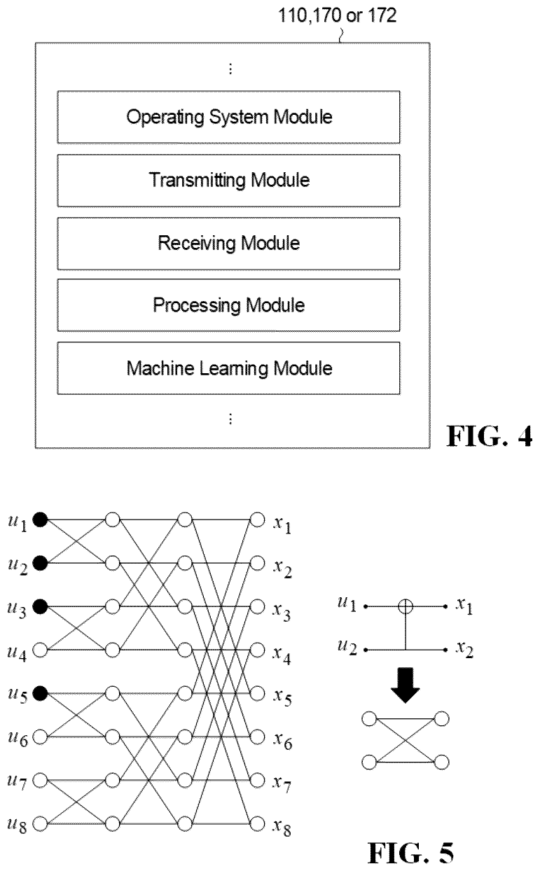

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

Successive cancellation (SC) is the basic decoding algorithm for polar codes, according to which all frozen bits and information bits are decoded sequentially, bit by bit. Preceding bits are always decoded first, before decoding a current bit.

Successive cancellation list (SCL) is an enhanced decoding algorithm for polar codes, where multiple (L) SC decoding instances are executed. Each instance is called a “decoding path”. When decoding each binary bit, both “0” and “1” branches are extended to each path, creating 2L paths. Then, all 2L paths are compared, where the most likely L paths are kept, and the least likely L paths are discarded (or pruned). The path extension and pruning operations are performed during decoding every information bit, until all information bits are decoded. At last, the most likely path is selected as the decoding output.

CRC-aided successive cancellation list (CA-SCL) decoding works almost the same as SCL, except that in the last step, the most likely path that passes CRC check is selected as the decoding output.

Parity-check successive cancellation list (PC-SCL) decoding also works almost the same as SCL, except that when decoding parity-check (PC) bits, the parity check value of associated preceding bits is used as a bit decision result. PC bits are in addition to frozen bits and information bits.

Polar codes are linear block codes. For a polar code of length N, its generator matrix is G_{N}, and its encoding process is

$${x}_{1}^{N} = {u}_{1}^{N} {G}_{N} ,$$

where

$${u}_{1}^{N} = [ {u}_{1} , {u}_{2} , … , {u}_{N} ]$$

is a binary information vector, and

$${x}_{1}^{N} = [ {x}_{1} , {x}_{2} , … , {x}_{N} ]$$

is the binary code vector. The N×N binary generator matrix

$${G}_{N} = {F}_{2}^{⊗ n} ,$$

where

$${F}_{2} = [ \begin{matrix}1 & 0 \\ 1 & 1\end{matrix} ]$$

is the polarization kernel matrix, Ð is Kronecker product, and n=where log₂ N.

With K information bits to be encoded into N code bits and K<N, a code rate of R=K/N<1 is obtained. This implies only part of

$${u}_{1}^{N}$$

is used to carry information bits, and the remining bits of

$${u}_{1}^{N}$$

are known as frozen bits. The information bit set (or information set) may be denoted by I, and the frozen bit set (or frozen set) may be denoted by F. Sometimes, there is an additional PC bit set, denoted by P. The frozen bits are known and usually set to all zeros before decoding, so they do not carry any information. The PC bits are parity-check bits of a subset of information bits, and therefore are known once the associated information bits are decoded. Decoding of polar codes attempts to recover all information bits.

Code length M may, but might not always, be a power of 2, in which case M<N. In practice, puncturing and shortening are used to reduce the number of transmitted code bits from N to M. For convenience, N is referred to as mother code length, and M is referred to as code length herein. In particular, punctured bits are untransmitted bits that are unknown to a decoder, but shortened bits are untransmitted bits that are known to the decoder (usually all zeros).

FIG. 5 is a trellis graph illustrating an example of a polar code with N=8 and K=4. Each “butterfly” in the graph is a polarization, and one butterfly is shown by way of example at the right in FIG. 5, for

$$x {}_{1}^{2} = u {}_{1}^{2} [ \begin{matrix}1 & 0 \\ 1 & 1\end{matrix} ] .$$

In the example shown, the unshaded circles at the left represent the information set I={u₄, u₆, u₇, u₈}, and the shaded circles represent the frozen set F={u₁, u₂, u₃, u₅}.

Rate-compatible polar coding is a key technology for wireless applications. One key characteristic of polar codes is that the actual reliability (or bit correct probability) of polarized subchannels is governed by channel output quality of all code bits. In the case of rate matching, some of the channel outputs are completely unknown (for punctured bits) or completely known (for shortened bits, which are not transmitted but are known). As a result, actual subchannel reliability will change dramatically according to any puncture patterns (which may also or instead be referred to as puncturing patterns) and/or shorten patterns (which may also or instead be referred to as shortening patterns). By definition of polar codes, the K information bits should be placed on the K most reliable polarized subchannels. If not, significant performance degradation will be observed.

In the 5G NR standard (see 3rd Generation Partnership Project (3GPP), “Multiplexing and channel coding,” 3GPP 38.212 V.15.3.0, 2018), a combination of puncturing, shortening, and repetition is used together with a fixed reliability sequence to balance performance and complexity. The goal is to puncture or shorten the code in a carefully designed way such that the relative ordering of polarized subchannels does not significantly change. This will facilitate code construction (i.e., the process of selecting K most reliable subchannels for placing K information bits) because the reliability ordering is fixed.

In particular, a subblock-wise interleaving, which may also be referred to as interlacing, is used for both puncturing and shortening in the 5G NR standard. The puncturing and shortening patterns are complementary and, together, form a symmetric (with respect to a polar code sequence) rate matching scheme.

With mother code length N, and code length M, the specific rate matching scheme used in 5G NR is as follows:
Repetition, when M>N;
Puncturing, when K/M≤7/16;
Shortening, when K/M>7/16.

Subblock-wise interleaving is performed before puncturing and shortening. An interleaver partitions the length-N mother code into 32 subblocks of size N/32 and interleaves them. Puncturing is performed from the first bit of a codeword, also referred to herein as a code bit, a coded bit, or an encoded bit, and shortening is performed from the last code bit. A rate matching module is efficiently implemented through a cyclic buffer. All mother code bits are placed in the cyclic buffer, puncturing is done by selecting the bits in clockwise order, and shortening is done by selecting bits in counter-clockwise order.

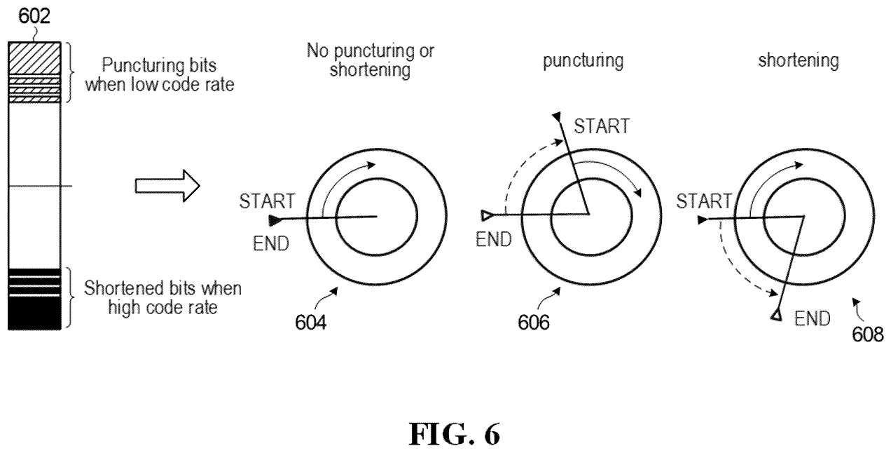

FIG. 6 is a diagram illustrating puncturing and shortening with a cyclic buffer. At 602 in FIG. 6, code bits of a codeword are illustrated in a vertical column, with punctured and shortened bits as shown. At 604, FIG. 6 illustrates a cyclic buffer, represented by a circle shape, and reading of code bits with no puncturing or shortening. The next two circles illustrate, respectively, cyclic buffers with dashed lines representing puncturing from the beginning of the buffer at 606 and shortening from the end of the buffer at 608.

Solutions that are different from the above-described 5G NR implementation are possible. An alternative solution is to fix the rate matching pattern by using only puncturing, which will inevitably change the reliability ordering, but perform code construction adaptively. In this case, the positions of the K most reliable subchannels will change according to the code length M. See R1-1708646, “FRANK polar construction for NR control channel and performance comparison”, Qualcomm Incorporated, 3GPP TSG RAN WG1 #89 Meeting, Hangzhou, P. R. China, May 15-19, 2017.

Two key features in this alternative solution are as follows:
Sequential puncturing: simply puncture the first P bits in the codeword.
Information bit allocation: allocate K information bits to K− bits and K+ bits, for the 1:N/2 bit positions and the N/2+1:N bits, respectively.

In the information bit allocation step, a rate allocation to match the number of information bits to the capacity of the channel after polarization is proposed. Denote by NPC the input channels (P+1:N) with indices that do not correspond to the indices of the first P punctured codeword bits, NPC₋ the degraded channels (P+1:N/2) after polarization, and NPC₊ the enhanced channels (N/2+1:N) after polarization. Under an additive white Gaussian noise (AWGN) channel, assuming the capacity of the input channels NPC is C, then the corresponding capacity C₋ and C₊ allocated to NPC₋ and NPC₊ satisfies the following:

$${C}_{+} = ( 1 + α ) - α {C}^{2} - δ$$

$${C}_{-} = α {C}^{2} + δ$$

$$where$$

$$α = \frac{N - 2 P}{N} ,$$

$$and$$

$$δ = α ( - \frac{\vert C - 0.5 \vert}{32} + \frac{1}{64} ) .$$

The number of information bits K− and K+ allocated to NPC₋ and NPC₊ can be calculated accordingly. The rate allocation is calculated recursively until reaching a specified length, such as 32.

These existing rate matching schemes provide flexible rates and lengths for polar codes. However, they have several drawbacks.

For example, the above-referenced 5G NR rate matching approach has many shortened bits, which are known at the receiver and thus cannot be transmitted for carrying additional information about source bits when code length needs to be increased. This drawback reduces the flexibility of the 5G NR rate matching scheme.

This approach also uses a combination of puncturing and shortening, and selection of puncturing or shortening is based on code rate. This rate-dependent rate matching incurs additional hardware logic and therefore slows down both encoding and decoding.

The above-referenced alternative solution is an example of a puncture-only scheme that requires recursive online calculations for rate allocation, and thus will have additional decoding latency. Moreover, it is not compatible with the existing reliability-ordered sequence-based code construction currently adopted for 5G.

Some embodiments disclosed herein are directed to addressing a technical problem related to providing low-complexity puncture-only rate matching for polar codes. 5G NR has adopted a rate-dependent rate matching scheme that involves shortening. In some embodiments, puncturing is preferred over hybrid puncturing and shortening, to help further reduce code construction complexity. A non-recursive information bit allocation approach is also disclosed, to help reduce code construction latency.

Disclosed embodiments may also or instead be relevant to a technical problem of providing reliability-ordered sequence-based rate matching. The currently adopted 5G NR polar code construction bases its rate matching on a length-1024 reliability-ordered sequence. For various reasons, such as compatibility or familiarity, it may be preferable to employ puncture-only rate matching, which still operates on top of a reliability-ordered sequence.

The present disclosure encompasses embodiments related to partial code rate reduction, adaptive partial code rate reduction, piece-wise partial code rate reduction, and a reliability sequence-based approach to allocate coding bit indices for information bits. Each of these embodiments is disclosed in detail by way of example herein.

After puncturing, the part of a codeword from which punctured bits are punctured, or more specifically the coding bit indices of input bit positions or subchannels associated with that part of a codeword, will be impacted by the puncturing. Puncturing impact may be characterized or observed as degraded capacity or degraded reliability associated with a bit index, for example. The punctured part of a codeword can no longer support the original amount of capacity for its associated bit indices. This result is due to the fact that the puncturing leaves a reduced number of code bits remaining for transmission. Partial code rate reduction as used herein refers to an approach in which, to better match capacity with code rate, the partial code rate corresponding to the punctured part of a codeword is reduced. In practice, the number of information bits in the part(s) of an input vector or set of bit indices corresponding to the punctured part(s) of a codeword is reduced to achieve this goal.

Partial code rate reduction may be implemented or provided by, in general, re-distributing code rates (or equivalently re-distributing bit indices for information bits) among different parts of a codeword, such that the local (partial) code rates of different parts of a codeword better match their capacity. One approach herein uses information bits and frozen bits, and another approach also uses bits that may be referred to herein as parity-check (PC) bits. The first approach may be referred to as a non-PC bit approach and the second approach may be referred to as a PC bit approach, for example, for ease of reference. PC bits may also or instead be referred to as check-type bits or related bits. All of these names are intended to convey the notion of a bit value of an input bit that is placed on multiple bit indices. In at least this sense, a PC bit, check-type bit, or related bit (or bit index) is related to an information bit (or bit index).

The non-PC bit approach is based on polar codes without PC bits. This approach may involve, in effect, re-allocating one or more information bits to other bit indices due to puncturing. This re-allocation may be accomplished in any of various ways, such as by code construction to allocate information bits to bit indices that are not negatively impacted or are at least less negatively impacted than other bit indices, by modifying or otherwise obtaining an ordered sequence that indicates bit indices in an order of rank for reducing the number of encoded bits (by puncturing in this example), or by moving bit indices from the frozen set to the information set, for example.

Consider a general example of constructing an (M, K) polar code. An (N, K) mother code may first be constructed, and then punctured to target code length M by puncturing P=N−M code bits according to a puncturing pattern. Puncturing of code bits also impacts corresponding or associated bit indices of subchannels (which may also be known as input bit positions to encoding).

For partial code rate reduction, a codeword is partitioned into multiple parts, also referred to herein as segments, denoted by S₁, S₂ . . . , where a vector Sᵢ contains bit indices of the code bits in the i-th segment. Regarding the size of each segment, denoted by Wᵢ, a power of 2 may be preferred, so that the resulting length of a codeword segment and the transmitted part thereof will more easily form a shorter polar code, for example.

Each segment may contain consecutive bit indices in the codeword. For example, considering a length-N codeword, if there are two segments then S₁=[1, 2 . . . . N/2] and S₂=[N/2+1, N/2+2 . . . . N]; or if there are four segments then S₁=[1, 2 . . . . N/4], S₂=[N/4+1, N/4+2 . . . N/2], S₃=[N/2+1, N/2+2 . . . 3·N/4] and S₄=[3·N/4+1, 3·N/4+2 . . . . N].

Interleaving may be applied before rate matching, and therefore in some embodiments each segment contains consecutive interleaved bit indices. Consecutive interleaved bit indices are bit indices that are in a sequential order after bit interleaving, and not in the order of those bit indices in a codeword. For example, suppose that code bits at indices [1, 2 . . . . N] in a codeword are first interleaved to [π(1), π(2) . . . π(N)] by a rate matching interleaver π, with the interleaver π being applied before sending the interleaved code bits into a rate matching circular buffer (for example) for puncturing. All of the bit indices in [1, 2 . . . . N] also appear in [π(1), π(2) . . . π(N)], but in [π(1), π(2) . . . π(N)] at least some of those bit indices are in a different order. Considering again a length-N codeword, if there are two equal-length segments then S₁=[π(1), π(2) . . . π(N/2)], and S₂=[π(N/2+1), π(N/2+2) . . . π(N)]; or if there are four equal-length segments then S₁=[π(1), π(2) . . . π(N/4)], S₂=[π(N/4+1), π(N/4+2) . . . π(N/2)], S₃=[π(N/2+1), π(N/2+2) . . . π(3·N/4)] and S₄=[π(3·N/4+1), π(3·N/4+2) . . . π(N)].

In both of these examples, with and without interleaving, each segment contains bit indices that are consecutive in terms of an input to rate matching, which is puncturing in these examples. The order of input to rate matching is the sequential order of bit indices in the codeword if there is no interleaving, and is the sequential order of bit indices after interleaving, which may be referred to as interleaved order, if interleaving is applied.

Another partitioning option is to partition a codeword into segments such that the number of punctured segments and the number of non-punctured segments are the same, and to map each punctured segment with a non-punctured segment. This mapping may be expressed as (Sᵢ→Sⱼ), where is Sᵢ is a punctured segment and Sⱼ is a non-punctured segment.

For partial code rate reduction, the code rate of the segment(s) with punctured bits is reduced. Code rate reduction may be applied or provided in respect of one or more segments with punctured code bits, regardless of how those segments have been generated from a codeword, for example whether the segments include consecutive codeword bit indices or consecutive interleaved bit indices.

In an embodiment, a rate reduction ratio α is obtained and used to calculate the new code rate R′ᵢ=α·Rᵢ, where Rᵢ and R′ᵢ are the code rate of the i-th segment before and after code rate reduction, respectively.

According to an embodiment, a reduction in the number of information bits in a corresponding input bit segment to encoding for the i-th (punctured) segment, is ΔKᵢ=Kᵢ-K′ᵢ=(1−α)·Rᵢ·Wᵢ, where Kᵢ and K′ᵢ are the numbers of information bit indices in the input bit segment corresponding to the i-th code bit segment before (Kᵢ) and after (K′ᵢ) partial code rate reduction. In the case where ΔKᵢ is not an integer, an operation such as rounding, a floor operation, or a ceiling operation may be performed to obtain an integer.

In some embodiments, code rate reduction involves the least reliable ΔKᵢ information bit indices in the input bit segment corresponding to the i-th code bit segment being flagged or otherwise changed or re-allocated from information bit indices to frozen bit indices. This may also be referred to as moving bit indices from the information set to the frozen set. The reliability of input bit indices for encoding may be defined by a pre-defined reliability ordering sequence, for example, such as that in 5G polar codes, and the least reliable ΔKᵢ information bit indices can be determined based on such a sequence.

To compensate for the impact of punctured code bits on the punctured segment, a local or partial code rate may be increased for the non-punctured segment(s) (i.e., those segments without punctured bits). In some embodiments, increasing the local or partial code rate involves the most reliable ΔKᵢ frozen bit indices in the input bit segment corresponding to the j-th (non-punctured) code bit segment being flagged or otherwise changed or re-allocated from frozen bit indices to information bit indices. This may also be referred to as moving bit indices from the frozen set to the information set. As noted above, the reliability of input bit indices for encoding may be defined by a pre-defined reliability ordering sequence, for example, and the most reliable ΔKᵢ frozen bit indices can be determined based on such a sequence.

The net effect of partial code reduction and corresponding partial code increase is that information bits are, in the examples above, moved from a puncture bit index (impacted by puncturing) to a non-puncture index (not negatively impacted, or at least not negatively impacted as much, by puncturing).

It should be noted, however, embodiments need not necessarily involve moving bit indices between sets, such as between an information set and a frozen set in the above examples, and/or a PC set in further examples below. Such re-allocation of bits, bit values, or bit indices, or placement of a bit value on a different bit index to reduce or increase a code rate could be considered a form of moving an input bit or bit value to one bit index from another bit index, copying an input bit or bit value to one bit index from another bit index, or redirecting an input bit or bit value to one bit index from another bit index, for example.

From a bit index perspective, placing an information bit or bit value on a different bit index to increase code rate may be considered a form of moving a bit index from one set of bit indices (the frozen set) to another set of bit indices (the information set) for placement of the input bit value, or re-marking or re-designating a bit index as an information bit index instead of a frozen bit index, for example. Similarly, from the perspective of a bit index that will no longer be used for placement of a bit value for encoding, placing an information bit or bit value on a different bit index to reduce code rate may be considered a form of moving a bit index from one set of bit indices (the information set) to another set of bit indices (the frozen set), or re-marking or re-designating the bit index as a frozen bit index instead of an information bit index.

Another way to interpret or express reducing code rate and/or increasing code rate as disclosed herein is that encoding involves placing a value of an input bit on a bit index in one set of bit indices (the information set, for placing values of the input bits) instead of on another bit index that is impacted by reducing the number of the encoded bits in the subset.

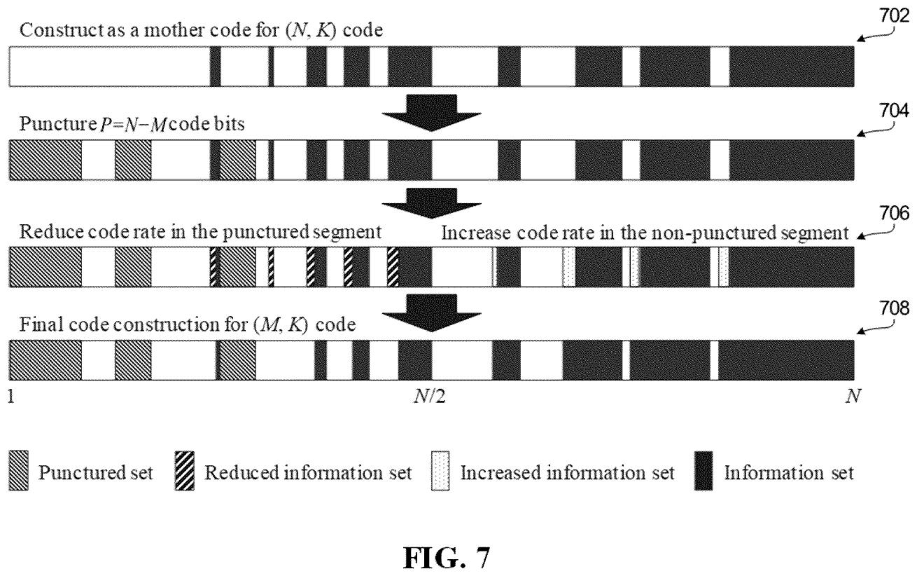

FIG. 7 is a diagram illustrating partial code rate reduction according to an embodiment. Each row in FIG. 7 relates to a respective step, operation, or stage of partial code rate reduction as described by way of example herein. The view in each row in FIG. 7 may be referred to as illustrating subchannels of a polar code, but for consistent terminology herein, reference is made to bit indices.

In the top row 702, FIG. 7 shows bit indices of an (N, K) mother code. Although not shown in the legend at the bottom of the drawing, the blank parts in the top row (and other rows) in FIG. 7 represent bit indices in the frozen set. The other parts in the top row of FIG. 7 represent K bit indices in an information set I, selected for placement of bit values of input bits. Bit indices in the information set may be bit indices of highest rank for placement of bit values, such as highest reliability bit indices, according to an ordered sequence such as a reliability ordered sequence for example.

As an illustrative example, suppose that a codeword is partitioned into two segments, including a (to be) punctured segment corresponding to the input bit indices 1 to N/2 in the left-hand half of each row in FIG. 7 and a non-punctured segment corresponding to the input bit indices N/2+1 to N in the right-hand half of each row in FIG. 7.

Although puncturing is performed on code bits rather than bits that are input to encoding, puncturing is shown in FIG. 7 to illustrate that puncturing code bits impacts corresponding bit indices for input to encoding, by degrading the actual reliability or capacity of those bit indices. With reference to the trellis in FIG. 5, for example, in theory, N−M punctured code bits, on the right-hand side of a trellis, will result in N−M bit indices, on the left-hand side of the trellis, having zero or near-zero capacity. For example, if the code bits x₁, x₂, . . . , xᵢ are punctured, then corresponding bit indices in the input vector u₁, u₂, . . . , uᵢ have zero or near-zero capacity. Returning again to FIG. 7, the punctured set in the second row 704 (and subsequent rows) represents the bit indices that correspond to punctured code bits.

The third row 706 in FIG. 7 represents partial code rate reduction in the left-hand segment (the bit indices in the reduced information set are the least reliable ΔKᵢ information bit indices in the left-hand segment in some embodiments), and also partial code rate increase in the right-hand segment (the bit indices in the increased information set are the most reliable ΔKᵢ frozen bit indices in the right-hand segment in some embodiments).

The last row 708 in FIG. 7 represents an example final code construction of an (M, K) code, with an information set, a frozen set, and a punctured set as shown. While FIG. 7 shows multiple logical steps for arriving at a final code construction 708, these steps need not each correspond to operations involving bit value placement in the bit indices of the input vector. In one option, for example, information and frozen bit values may be placed in the mother code at 702, and then some of those values may be changed after partial rate reduction at 706. In another option, for example, bit values for information and frozen bits may be directly placed at their respective bit indices in the final code construction at 708.

Additional details regarding partial code rate reduction, including examples of how to determine α, are provided elsewhere herein, including at least below.

In these non-PC bit examples, only information bit indices and frozen bit indices are used in partial code rate reduction. In another embodiment, partial code rate reduction is based on PC polar codes. This may involve moving or otherwise placing fewer information bits onto different bit indices to compensate for effects of puncturing, because in PC polar codes a bit value may be placed on multiple bit indices, including bit indices in one or more punctured segments and bit indices in one or more non-punctured segments.

Starting again with the context of a general example of constructing an (M, K) polar code, an (N, K) mother code may first be constructed, and then punctured to target code length M by puncturing P=N−M code bits according to a puncturing pattern. A codeword is partitioned into segments, and any of the partitioning approaches described by way of example herein, including those described above for non-PC bit embodiments, may be used.

In PC bit embodiments, bit values on information bit indices that are associated with punctured segments may also be placed on bit indices or in subchannels that are associated with non-punctured segments. In some embodiments, each non-punctured segment is supplemented or reconstructed by additionally including information bits from a corresponding punctured segment with which it is mapped.

For an (Sᵢ↔Sⱼ) segment pair, for example, where Sᵢ is punctured and Sⱼ is not punctured, suppose that the numbers of corresponding information bits are Kᵢ and Kⱼ, respectively. In this example, reconstruction of Sⱼ may involve reconstructing a (Wᵢ, Kᵢ+Kⱼ) code for Sⱼ to have Kᵢ+Kⱼ bit indices for information bits, where the Kᵢ additional information bits are placed on bit indices for Sⱼ that were previously frozen. The additional information bits may be placed on the Kᵢ most reliable bit indices among bit indices in Sⱼ that were previously frozen, before Sⱼ was supplemented or reconstructed. For ease of reference, denote by Iᵢ the information set corresponding to Sᵢ.

Suppose that the combination of Sᵢ (before puncturing) and Sⱼ (after adding the Kᵢ additional information bits) were to be decoded together as a long code. The Kᵢ additional information bits would be decoded from Sᵢ, and therefore they become PC bits for Sⱼ. For ease of reference, denote by Xⱼ the PC set for Sⱼ. With this notation, we have |Iᵢ|=|Xⱼ|, because Iᵢ and Xⱼ have the same size.

The mapping orders from input or source bits [a₁, a₂ . . . a_{Ki}] to bit indices corresponding to code bit positions in Sᵢ and Sⱼ may be different. Specifically, if [a₁, a₂ . . . a_{Ki}] are placed on Iᵢ for Sᵢ by ascending (or descending) reliability order for example, then [a₁, a₂ . . . a_{Ki}] may be placed on Xⱼ for Sⱼ by descending (or ascending) reliability order. As seen, the orders are opposite (or reverse) to each other in this example.

The example above relates to code reconstruction on a mapped-segment basis, between a punctured segment and the non-punctured segment with which it is mapped. In another embodiment, all non-punctured segments are reconstructed together, by additionally including the information bits corresponding to all punctured segments. In this type of reconstruction, all punctured segments are bundled together and considered as a whole, and similarly all non-punctured segments are also bundled together and considered as a whole.

For all punctured segments, denoted by {Sᵢ} as their union set, their total number of corresponding information bits is ΣKⱼ. For all non-punctured segments, denoted by {Sⱼ} as their union set, their total number of information bits is ΣKⱼ, and their total length is ΣWⱼ. In this example, reconstruction may involve reconstructing a (ΣWⱼ, ΣKᵢ+ΣKⱼ) code for {Sⱼ} to have ΣKᵢ+2Kⱼ information bits, where the ΣKᵢ additional information bits are placed on bit indices, such as the most reliable bit indices, for {Sⱼ} that were previously frozen. For ease of reference, denote by {Iᵢ} the information set corresponding to {Sᵢ}.

If the combination of {Sᵢ} (before puncturing) and {Sⱼ} (after adding the ΣKᵢ additional information bits to its information set) were to be decoded as a long code, then the EK; additional information bits would be decoded in {Sᵢ} and therefore they become PC bits for {Sⱼ}. For ease of reference, denote by {Xⱼ} the PC set for {Sⱼ}, and with this notation we have |{Iᵢ}|=|{Xⱼ}|, because {Iᵢ} and {Xⱼ} have the same size.

The mapping orders from input or source bits [a₁, a₂ . . . a_{ΣKi}] to bit indices corresponding to code bit positions in {Sᵢ} and {Sⱼ} may be different. Specifically, if [a₁, a₂ . . . a_{ΣKi}] are placed on {Iᵢ} for {Sᵢ} by ascending (or descending) reliability order for example, then [a₁, a₂ . . . a_{ΣKi}] may be placed on {Xⱼ} for {Sⱼ} by descending (or ascending) reliability order. As seen, the orders are opposite (or reverse) to each other in this example.

Partial code rate reduction to reduce code rate for the segment(s) with punctured bits may proceed as described at least above for non-PC bit embodiments. For example, in some embodiments the least reliable ΔKᵢ information bit indices in the segment corresponding to the i-th code bit segment are flagged or otherwise changed or re-allocated from information bit indices to frozen bit indices.

In non-PC bit embodiments described above, compensating for the impact of punctured code bits on the punctured segment may involve increasing the code rate for the non-punctured segment(s), by flagging or otherwise changing or re-allocating the most reliable ΔKᵢ frozen bit indices in the segment corresponding to the j-th code bit segment from frozen bit indices to information bit indices for example. In PC bit embodiments, PC bit indices for the non-punctured segment(s) may become information bit indices. This may be referred to as releasing the PC bits or bit indices.

In some embodiments, at least some of the information bit indices, such as the least reliable information bit indices, for the punctured segment(s) are set to frozen for the partial code rate reduction, and accordingly their values are not decodable from the non-punctured segment(s). The corresponding PC bit positions for the non-punctured segment(s) would still be decodable from the non-punctured segment(s), and therefore may, in effect, become or be treated as information bit indices.

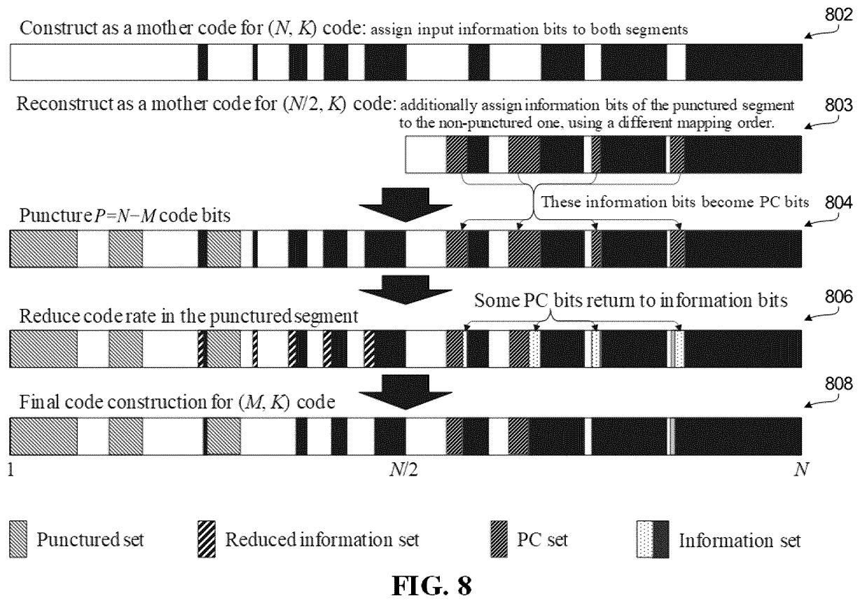

FIG. 8 is a diagram illustrating partial code rate reduction according to another embodiment, this time a PC bit embodiment. Each row in FIG. 8 relates to a respective step, operation, or stage of partial code rate reduction as described by way of example herein.

In the top row 802, FIG. 8 shows bit indices of an (N, K) mother code. As in FIG. 7, the blank parts in the top row (and other rows) in FIG. 8 represent frozen bit indices, and the other parts in the top row of FIG. 8 represent K information bit indices that are selected for placement of bit values of input bits that are to be encoded. Considering an example of two segments with bit indices 1 to N/2 corresponding to the left-hand side of each full row and bit indices N/2+1 to N corresponding to the right-hand side of each full row, as above for FIG. 7, information bit indices are assigned for both segments.

Reconstruction of the non-punctured segment to the right is shown by the half row 803 below the first row 802 in FIG. 8. Information bits for the punctured (left) segment are additionally assigned for the non-punctured (right) segment, possibly using a different mapping order as described in further detail by way of example at least above. Assigning information bits from the punctured segment to non-punctured segment involves creating a relationship between respective bit indices of the punctured and non-punctured segments. The relationship may be a one-to-one relationship, such that an information bit value in the punctured segment is copied, duplicated, replicated, mirrored, etc. to the non-punctured segment. The relationship may be a many-to-one relationship, such that a bit value in the non-punctured segment is generated from a combination of bit values in the punctured segment. For example, a combination of bit values may be realized by performing an XOR operation (i.e., sum modulo 2) on the bit values. The PC set in the half row 803 represents the bit indices of the non-punctured segment to be used for assigning the information bits from the punctured segment, as shown in the second full row 804 in FIG. 8.

Puncturing is also shown in the second full row 804 in FIG. 8 to illustrate, as in FIG. 7, that puncturing code bits impacts corresponding information bit indices, by degrading actual reliability or capacity of the information bit indices. The punctured set in the second full row (and subsequent rows) in FIG. 8 represents the bit indices or subchannels that correspond to punctured code bits.

For partial code rate reduction, at least some of the information bit indices, including least reliable information bit indices for example, for a punctured segment may be set to frozen. Input bit values for those indices are no longer decodable from the punctured segment. The corresponding PC bit indices for the non-punctured segment are decodable from the non-punctured segment, and therefore may become or be treated as information bit indices. In one sense, this partial code rate reduction severs the relationship between the PC bit value(s) in the non-punctured segment and the information bit value(s) formerly in the punctured segment, yet the PC bit value still carries information; thus, the PC bit indices corresponding to these former information bit indices may be considered to revert to, return to, or otherwise simply be treated as information bit indices. This is shown in the third full row 806 in FIG. 8.

The last row 808 in FIG. 8 represents an example final code construction of an (M, K) code, with an information set, a frozen set, a PC set including any PC bits that remain after partial code rate reduction, and a punctured set as shown. While FIG. 8 shows multiple logical steps for arriving at a final code construction 808, these steps need not each correspond to operations involving bit value placement in the bit indices of the input vector. In one option, for example, information and frozen bit values may be placed in the mother code at 802, PC bit values placed in the segment at 803, and then some of those values may be changed after partial rate reduction at 806. In another option, for example, bit values for information, PC, and frozen bits may be directly placed at their respective bit indices in the final code construction at 808.

The examples above relate to partial code rate reduction. Embodiments referred to herein as adaptive partial code rate reduction provide partial code rate reduction approaches, including how to determine the rate reduction ratio α, in an adaptive manner depending on code rate and/or a length such as punctured length, for example.

The code rate reduction ratio α specifies the degree of code rate reduction in the punctured segment(s). It is defined by α=R′ᵢ/Rᵢ, where Rᵢ and R′ᵢ are the segment code rate of the i-th segment before and after code rate reduction, respectively.

A code rate-dependent code rate reduction ratio α_{R}, for example, may be defined as a function of a code rate. Illustrative examples include α_{R} being a monotonically increasing function of a code rate, α_{R} being equal to a code rate, and α_{R} being equal to a code rate multiplied by a constant such as 1/8, 1/4, 3/8, 1/2, 5/8, 3/4, 7/8. These are examples only, and α_{R} may be consistent with other functions of a code rate or otherwise dependent upon a code rate.

These examples in respect of α_{R} intentionally refer to “a” code rate. This is intended to illustrate that α_{R} may be dependent upon any of various different types of code rate. Illustrative examples include the following:
a target or final code rate K/M;
mother code rate K/N;
a “short” code rate such as K/(N/2)=2·K/N;
a code rate of a mapped pair of punctured and non-punctured segments, which may be expressed as follows: Rᵢ₋ⱼ=(Kᵢ+Kⱼ)/(Wᵢ+Wⱼ);
an original code rate of a punctured segment, which may be expressed as follows:

$${R}_{i} = {K}_{i} / {W}_{i} ;$$

a code rate of a non-punctured segment, which may be expressed as follows: Rⱼ=Kⱼ/Wⱼ.

A puncture-dependent code rate reduction ratio α_{P} may be defined as a function of a length, such as a monotonically decreasing function of a punctured length. This punctured length may be, for example, a total punctured length P=N−M, or punctured length Pᵢ of a punctured segment. According to another example function, α_{P}=N/(c_{α}·P+N), where c_{α} is a predefined constant such as 2, 4, 8, 16, 32, 64, 128, 256. A further example function for a puncture-dependent code rate reduction ratio is α_{P}=d_{α}·N/(c_{α}·P+N), where d_{α} is another predefined constant such as 1/8, 1/4, 3/8, 1/2, 5/8, 3/4, 7/8. P may be substituted with Pᵢ in the two latter example functions.

Hybrid or jointly-dependent embodiments are also possible. For example, a joint rate-and-puncture-dependent code rate reduction ratio α may be determined as a function, such as a product, of α_{R} and α_{P}. The following is an illustrative example: α=α_{R}·α_{P}.

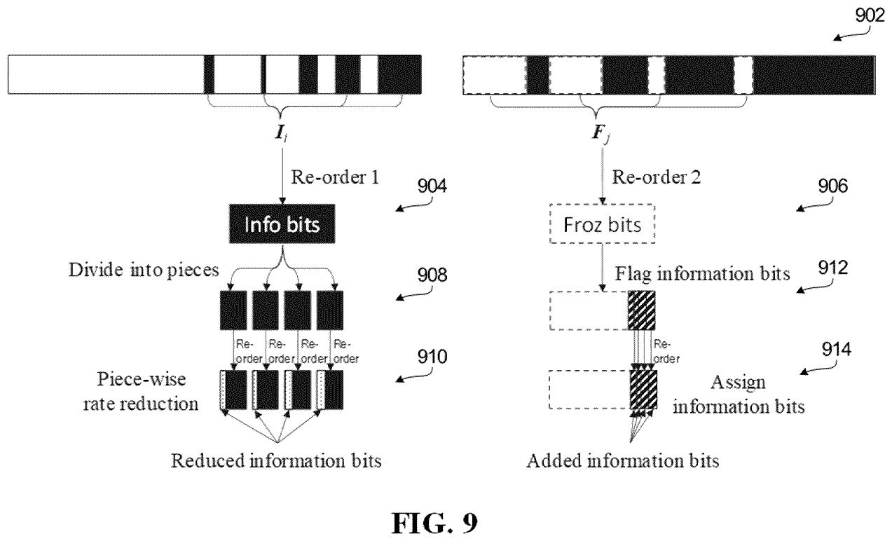

To achieve finer-grained code rate reduction, especially within each punctured segment, piece-wise partial code rate reduction is proposed. For piece-wise partial code rate reduction, a punctured segment is further divided into several “pieces”, and code rate reduction can be applied separately to each piece. An example of piece-wise partial code rate reduction is illustrated in FIG. 9. The blank parts in the top row 902 in FIG. 9 represent frozen bit indices, and the other parts in the top row of FIG. 9 represent information bit indices.

Embodiments disclosed herein encompass non-PC bit embodiments and PC bit embodiments. For non-PC bit piece-wise partial code rate reduction, some information bits are re-allocated to other positions or subchannels to compensate for puncturing.

In an embodiment, information bits are first re-ordered by separately permuting the Kᵢ information bit indices in Iᵢ for Sᵢ into αᵢ(Iᵢ) 904, and all the frozen bit indices in Fⱼ for Sⱼ into πⱼ(Fⱼ) 906, respectively. The orders of bit indices in Stand Sⱼ can be different. For example, ordering can be chosen from the following:
ascending or descending rank, such as reliability;
ascending or descending bit index;
a pre-defined bit interleaver;
transmission order.

Information bits 904 are then divided or partitioned into pieces 908, which is different from previous examples of dividing code bits into segments in that here the information bits, rather than the code bits, are being divided or partitioned. The information bit indices in Iᵢ for Sᵢ are divided into q subblocks, where q is preferably power of 2 and the subblocks can be of equal size. Ending bit indices of the subblocks are multiples of a power of 2 where mother code length is a power of 2 and q is also a power of 2, for example. The respective numbers of information bit indices in the q subblocks are denoted by Kᵢ₁, Kᵢ₂, Kᵢ₃ . . . . K_{iq}, and with Kᵢ information bit indices for Sᵢ, Kᵢ=Kᵢ₁+Kᵢ₂+Kᵢ₃+ . . . +K_{iq}. In an embodiment, there may be re-ordering within each part, according to the orders described above for Sᵢ for example.

Piece-wise code rate reduction 910 for Sᵢ proceeds with separately reducing code rate of each of the q pieces. A respective code rate reduction ratio from a set of ratios αᵢ₁, αᵢ₂, αᵢ₃ . . . α_{iq} is multiplied with Kᵢ₁, Kᵢ₂, Kᵢ₃ . . . K_{iq} in an embodiment, to obtain a respective K′ᵢ, K′ᵢ₂, K′ᵢ₃ . . . . K′_{iq} as the new (reduced) number of information bit indices in each piece. The reduction in the number of information bit indices in each piece is ΔKᵢ₁, ΔKᵢ₂, ΔKᵢ₃ . . . ΔK_{iq}, respectively. In an embodiment, bit indices such as the least reliable ΔKᵢ₁, ΔKᵢ₂, ΔKᵢ₃ . . . ΔK_{iq} or otherwise lowest rank bit indices in the q pieces are flagged or otherwise re-allocated as frozen bit indices. In this example, the overall reduction in the number of information bit indices for Sᵢ is ΔKᵢ=ΔKᵢ+ΔKᵢ₂+ΔKᵢ₃+ . . . +ΔK_{iq}.

Frozen bits for Sⱼ may then be flagged or otherwise re-allocated as information bit indices 912, to compensate for the reduction in the number of information bit indices for Sᵢ. In particular, in some embodiments the ΔKᵢ most reliable or otherwise highest rank bit indices in F; are flagged as information bit indices. The ΔKᵢ newly-flagged information bit indices for Sⱼ can be further divided into pieces of size ΔKᵢ₁, ΔKᵢ₂, ΔK_{iq} . . . ΔK_{iq}, and re-ordered within each piece, according to the orders described above for the information bit indices for Sⱼ for example.

The newly flagged information bit indices for Sⱼ are assigned input bit values 914 (also referred to herein as placing bit values on bit indices) from the previous information bit indices for Sᵢ before encoding. In particular, bit values that were placed on or were to be placed on the re-ordered ΔKᵢ₂, ΔKᵢ₃ . . . ΔK_{iq} information bit indices in the q pieces for Sᵢ are placed on the re-ordered ΔKᵢ₂, ΔKᵢ₃ . . . ΔK_{iq} information bit indices in the q pieces in Sⱼ one-by-one, sequentially.

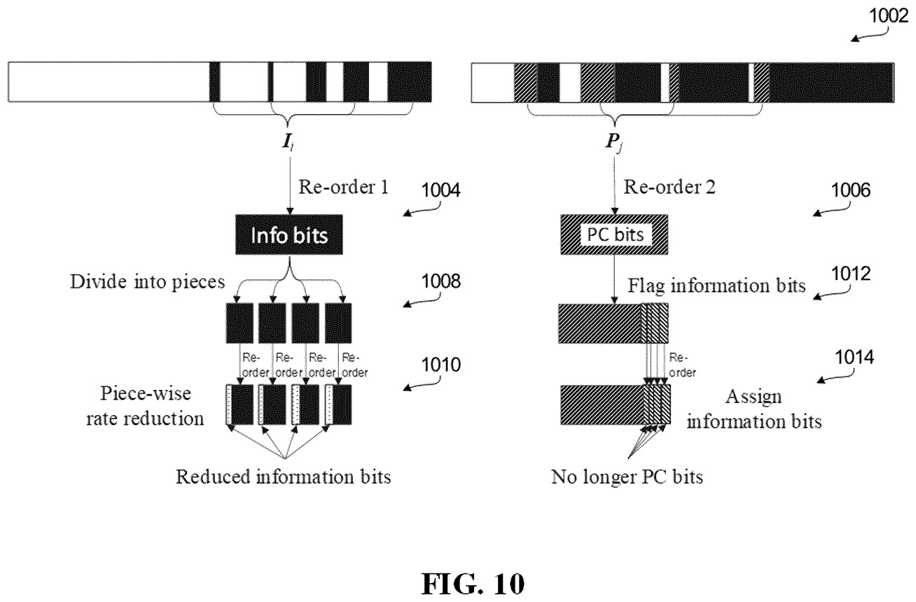

Another example of piece-wise partial code rate reduction is illustrated in FIG. 10. The blank parts in the top row 1002 in FIG. 10 represent frozen bit indices, and the other parts in the top row of FIG. 10 represent information bit indices or PC bit indices.

For PC bit piece-wise partial code rate reduction, consider again an illustrative example of the (Sᵢ↔ⱼ) mapped segment pair, where Sᵢ is punctured and Sⱼ is not punctured, and the number of information bit indices in Sᵢ and Sⱼ are Kᵢ and Kⱼ, respectively. A (Wᵢ, Kᵢ+Kⱼ) code is reconstructed for Sⱼ to have Kᵢ+Kⱼ information bits, where bit values of the Kᵢ additional information bits are placed on bit indices, such as the most reliable or otherwise highest rank bit indices for Sⱼ that were previously frozen. As above, Iᵢ denotes the set of Kᵢ information bit indices for Sᵢ, and Xⱼ denotes the set of additional Kᵢ information bit indices for Sⱼ in reconstructing the (Wᵢ, Kᵢ+Kⱼ) code. In the PC bit case, the bit values placed on the Kᵢ information bits from bit indices Iᵢ for Sᵢ are also placed on the bit indices Xⱼ for Sⱼ. The Kᵢ information bits for Sᵢ may be decoded earlier, and accordingly the same bit values placed on the Kᵢ information bits in Sⱼ may become or be treated as PC bits.

In an embodiment, similar to the non-PC bit example above, information bits may first be re-ordered by separately permuting the Kᵢ information bit indices Iᵢ for Sᵢ into πᵢ(Iᵢ) 1004, and the PC bit indices Xⱼ for Sⱼ into πⱼ(Xⱼ) 1006, respectively. The orders of bit indices in Sᵢ and Sⱼ can be different. For example, ordering can be chosen from the following:
ascending or descending rank such as reliability;
ascending or descending bit index;
a pre-defined bit interleaver;
transmission order.

Information bits 1004 may then be divided or partitioned into pieces 1008, which is different from previous PC bit examples of dividing code bits into segments in that here the information bits, rather than the code bits, are being divided or partitioned. The information bit indices in Iᵢ for Sᵢ are divided into q subblocks, where q is preferably power of 2 and the subblocks can be of equal size. Ending bit indices of the subblocks are multiples of a power of 2 where mother code length is a power of 2 and q is also a power of 2, for example. The respective numbers of information bit indices in the q subblocks are denoted by Kᵢ₁, Kᵢ₂, Kᵢ₃ . . . . K_{iq}, and with Kᵢ information bit indices for Sᵢ, Kᵢ=Kᵢ₁+Kᵢ₂+Kᵢ₃+ . . . +K_{iq}. In an embodiment, there may be re-ordering within each part, according to the orders described above for Sᵢ for example.

Piece-wise code rate reduction 1010 for Sᵢ proceeds with separately reducing code rate of each of the q pieces. A respective code rate reduction ratio from a set of ratios di, die, dig . . . α_{iq} is multiplied with Kᵢ₁, Kᵢ₂, Kᵢ₃ . . . . K_{iq} in an embodiment, to obtain a respective K′ᵢ₁, K′ᵢ₂, K′ᵢ₃ . . . K′_{iq} as the new (reduced) number of information bits in each piece. The reduction in the number of information bits in each piece is ΔKᵢ₁, ΔKᵢ₂, ΔKᵢ₃ . . . ΔK_{iq}, respectively. In an embodiment, the least reliable ΔKᵢ₁, ΔKᵢ₂, ΔKᵢ₃ . . . ΔK_{iq} bits in the q pieces are flagged or otherwise re-allocated as frozen bits. In this example, the overall reduction in the number of information bits for Sᵢ is ΔKᵢ=ΔKᵢ₁+ΔKᵢ₂+ΔKᵢ₃+ . . . +ΔK_{iq}.

As a result of this type of code reconstruction, there is a one-to-one mapping from the ΔKᵢ information bits for Sᵢ to the ΔKᵢ PC bits for Sⱼ. Because the ΔKᵢ information bit indices previously in Sᵢ are no longer no longer information bit indices as a result of the code rate reduction, the ΔKᵢ PC bits Sⱼ are no longer PC bits, because they no longer have corresponding information bits that are decodable from Sᵢ. The bit indices for these PC bits for Sⱼ may then be flagged or otherwise re-allocated or treated as information bit indices 1012.

The ΔKᵢ newly-flagged information bit indices for Sⱼ are the ΔKᵢ most reliable or otherwise highest bit indices for Xⱼ in some embodiments. These ΔKᵢ newly-flagged bit indices for Sⱼ can be further divided into pieces of size ΔKᵢ₁, ΔKᵢ₂, ΔKᵢ₃ . . . ΔK_{iq}, and re-ordered within each piece according to the orders described above for the information bit indices for Sⱼ for example.

Bit values may be placed on the newly flagged information bit indices for Sⱼ from the previous information bit indices for Sᵢ before encoding 1014. In particular, bit values that are placed or were to be placed on the re-ordered ΔKᵢ₂, ΔKᵢ₃ . . . ΔK_{iq} information bit indices in the q pieces for Sᵢ may be placed on the re-ordered ΔKᵢ₂, ΔKᵢ₃ . . . ΔK_{iq} information bit indices in the q pieces in Sⱼ one-by-one, sequentially.

Another aspect of the present disclosure relates to parameterized configuration and/or parameter-based description, which may be particularly convenient and efficient for piece-wise partial code rate reduction. Piece-wise partial code rate reduction as disclosed herein involves separately reducing code rate in blocks or pieces into which information bit indices are divided, potentially using different code rate reduction ratios.

For example, for parameterized configuration and/or parameter-based description of partial code rate reduction, two parameter vectors may be sufficient to describe a wide range of code rate reduction configurations.

A segment or piece size vector [Wi₁, Wi₂, Wi₃ . . . ], where each element specifies the size W of a segment or piece to be separately code rate reduced, may be used to configure and/or describe the sizes of blocks for separate code rate reduction. Size may be indicated or represented in any of various ways, as an absolute number of bit indices per segment or piece or as a relative number or measure for example. A relative number with respect to mother code length N, for example, may indicate size as a portion of mother code length, such as 1/4 to indicate that size is N/4. An equivalent relative measure is the number of equal-size segments or pieces per mother codeword, in which case a value of 4, for example, also indicates a block size of N/4.

A code rate reduction vector [αᵢ₁, αᵢ₂, αᵢ₃ . . . ], wherein each element specifies the code rate reduction ratio for each segment or piece, may be employed in some embodiments. Special cases may be indicated by particular values. For example, a special case may be α=1, or another special value or symbol, to indicate no code rate reduction.

Table 1 below provides an example of a two-vector parameter-based configuration or description format for partial code rate reduction.

TABLE 1
Example Two-Vector Partial Code Rate Reduction Parameter Table

| Piece size | Wᵢ₁ | Wᵢ₂ | Wᵢ₃ | . . . |
|---|---|---|---|---|
| Rate reduction | αᵢ₁ | αᵢ₂ | αᵢ₃ | . . . |

Populated table examples consistent with Table 1 are provided below. Table 1 and the populated examples below are provided only as illustrative examples. The present disclosure is not in any way limited to these particular examples.

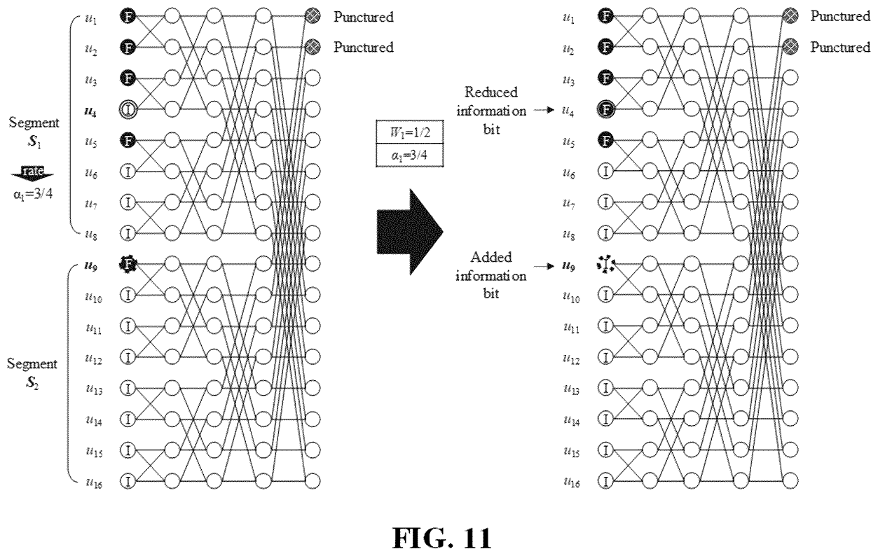

Consider first an example parameterized configuration and code construction without PC bits. FIG. 11 includes trellis graphs illustrating partial code rate reduction according to this example. In FIG. 11, “F” and “I” at the left side of each trellis indicate “frozen” and “information” bit indices, respectively. The example illustrated in FIG. 11 shows, in particular, an (M=14, K=11) polar code, with an information set under mother code length N=16 of I={4, 6, 7, 8, 10, 11, 12, 13, 14, 15, 16}, and a frozen set of F={1, 2, 3, 5, 9}. Sequential puncturing is applied to the codeword. The punctured set is P={1, 2}.

Table 2 below is populated with parameter values for this example.

TABLE 2
Example Parameters for Two-Segment
Partial Code Rate Reduction

| Piece size | W₁ = 1/2 |
|---|---|
| Rate reduction | α₁ = 3/4 |

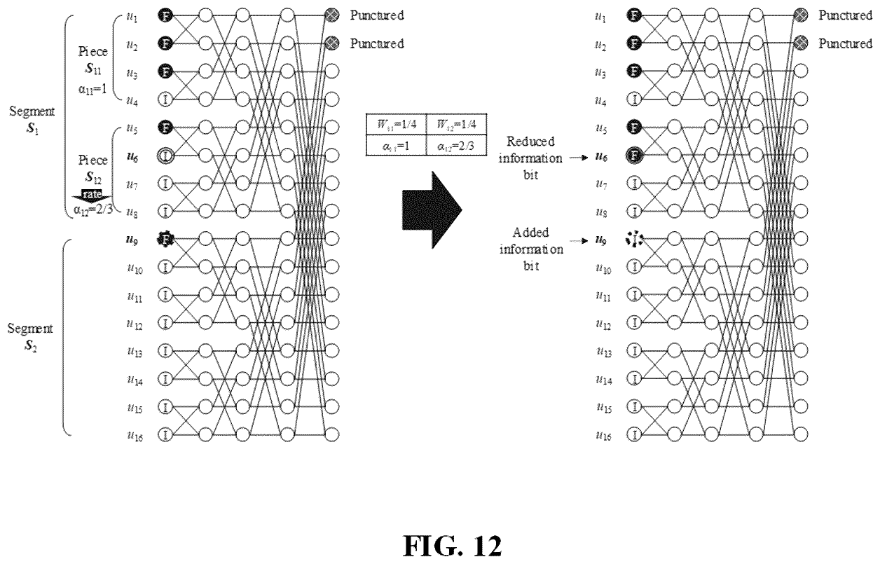

Consider now another example parameterized configuration and code construction without PC bits, but with piece-wise partial reduction. FIG. 12 includes trellis graphs illustrating partial code rate reduction according to this example. “F” and “I” at the left side of each trellis indicate “frozen” and “information” bit indices, respectively. This example uses the same (M=14, K=11) polar code as the preceding example, with an information set under mother code length N=16 of I={4, 6, 7, 8, 10, 11, 12, 13, 14, 15, 16}, and a frozen set of F={1, 2, 3, 5, 9}. As above, sequential puncturing is applied to the codeword and the punctured set is P={1, 2}.

Again suppose that there are two segments, including a punctured segment Sᵢ=[1, 2, 3, 4, 5, 6, 7, 8] and a non-punctured segment S₂=[9, 10, 11, 12, 13, 14, 15, 16], but that S₁ is further divided into two pieces S₁₁=[1, 2, 3, 4] and S₁₂=[5, 6, 7, 8]. For the (S₁↔S₂) segment pair, a code rate reduction ratio α₁=3/4 is applied to S₁. With a code rate reduction ratio α₁₁=1 (no rate reduction) for S₁₁ and α₁₂=2/3 for S₁₂, the least reliable information bit u₆ (at bit index 6) for S₁₂ is frozen, or in other words bit index 6 may be moved from the information set to the frozen set, and the most reliable frozen bit u₉ (at bit index 9) for S₂ is added as an information bit, or in other words bit index 9 may be moved from the frozen set to the information set. Again, as noted elsewhere herein, moving bit indices between sets is one way, but not the only way, to provide or support reducing code rate reduction and/or increasing code rate.

Table 3 below is populated with parameter values for this example.

TABLE 3
Example Parameters for Piece-wise Partial Code Rate Reduction

| Piece size | W₁₁ = 1/4 | W₁₂ = 1/4 |
|---|---|---|
| Rate reduction | α₁₁ = 1 | α₁₂ = 2/3 |

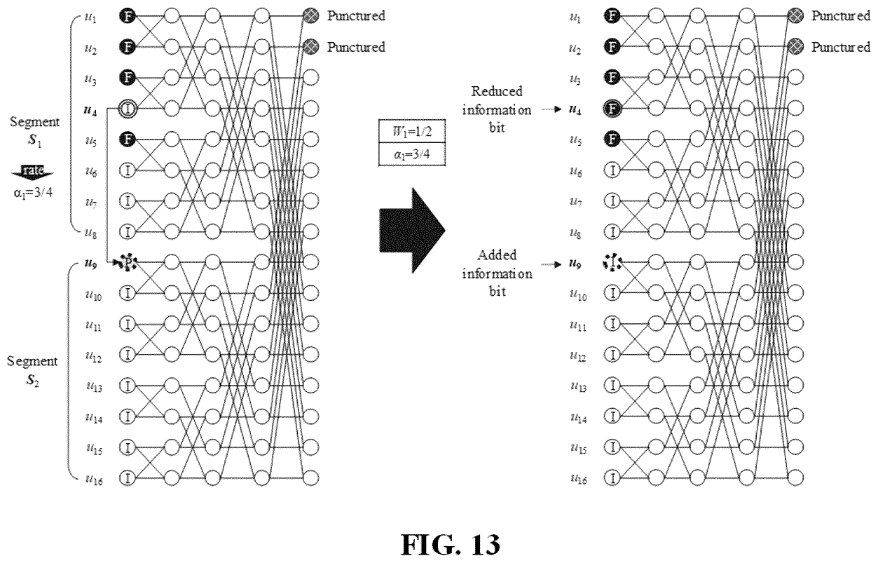

A parameterized configuration and code construction for a PC bit example is illustrated in FIG. 13, which includes trellis graphs illustrating partial code rate reduction according to this example. “F” and “I” at the left side of each trellis in FIG. 13, and “P” at the left side of the left trellis, indicate “frozen”, “information”, and “PC” bit indices, respectively. Table 2 above includes parameter values for this example.

As shown in FIG. 13, the example includes an (M=14, K=11) polar code having an information set under mother code length N=16 of I={4, 6, 7, 8, 10, 11, 12, 13, 14, 15, 16}, a frozen set of length 4 (instead of 5 in the preceding examples) F={1, 2, 3, 5}, and a PC set of X={9}. The corresponding PC function that defines or describes a relationship between bit values on multiple bit indices in this example is u₄=u₉.

With sequential puncturing of the codeword, the punctured set is P={1, 2}, and as in other examples suppose that there are two segments, including a punctured segment Sᵢ=[1, 2, 3, 4, 5, 6, 7, 8] and a non-punctured segment S₂=[9, 10, 11, 12, 13, 14, 15, 16].

For the (S₁↔S₂) segment pair, with a rate reduction ratio α₁=3/4 applied to S₁, the least reliable information bit u₄ in S₁ becomes frozen (bit index 4 may be moved from the information set to the frozen set), and the most reliable PC bit u₉ in S₂ is added as an information bit (bit index 9 may be moved from the frozen set to the information set).

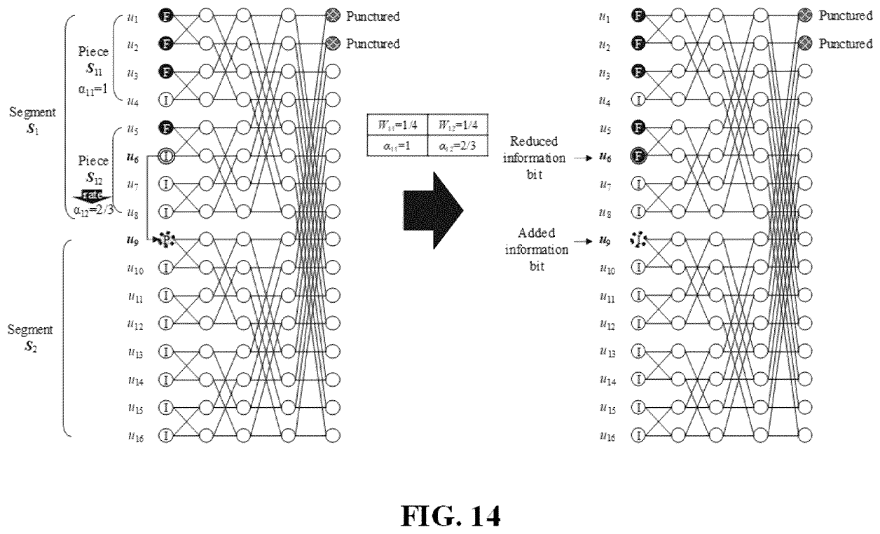

Another example parameterized configuration and code construction is used to illustrate piece-wise partial code rate reduction with PC bits. Table 3 above includes parameter values for this example, and FIG. 14 includes trellis graphs illustrating partial code rate reduction according to this example. “F” and “I” at the left side of each trellis in FIG. 14, and “P” at the left side of the left trellis, indicate “frozen”, “information”, and “PC” bit indices, respectively.

At the left side of the example in FIG. 14, the code construction starts with a same initial code as in the previous PC bit example of FIG. 13. This particular example shows an (M=14, K=11) polar code, with information set under mother code length N=16 of I={4, 6, 7, 8, 10, 11, 12, 13, 14, 15, 16}, frozen set of F={1, 2, 3, 5}, and PC set of X={9}. Sequential puncturing is applied to the codeword, and the punctured set is P={1, 2}. Again there are two segments, including a punctured segment S₁=[1, 2, 3, 4, 5, 6, 7, 8] and a non-punctured segment S₂=[9, 10, 11, 12, 13, 14, 15, 16], but S₁ is further divided into two pieces S₁₁=[1, 2, 3, 4] and S₁₂=[5, 6, 7, 8].

After rate reduction, the code construction for the example in FIG. 14 differs from the example in FIG. 13, as seen on the right side of the respective examples. Notably, rate reduction for the example in FIG. 13 is performed over the segment S₁, whereas rate reduction for the example in FIG. 14 is performed over the piece S₁₂.

With a rate reduction ratio α₁₁=1 (no rate reduction) for Su and α₁₂=2/3 for S₁₂, the least reliable information bit u₆ for S₁₂ is frozen (bit index 6 moved from the information set to the frozen set), and the most reliable PC bit u₉ for S₂ is added as an information bit (bit index 9 may be moved from the frozen set to the information set).

The foregoing embodiments focus primarily on explicitly specifying code rate adjustments for certain blocks of codewords or inputs, which may be referred to as parts, pieces, segments, subblocks, subcodes, etc. In other embodiments, an approach that is based on a reliability sequence may instead be used for partial code rate adjustment. This type of sequence-based approach may be referred to as “implicit” in the sense that code rate reduction may be built into a reliability sequence, and therefore obtaining information bit indices, frozen bit indices (and PC bit indices, if any) from such a sequence has code rate reduction implicitly built in. An approach based on a reliability sequence may be more straightforward and simpler for implementation, but may still achieve the same goal as other embodiments disclosed herein, because modifying a sequence, by setting lower reliability value(s) or other ranking parameter(s) for certain bit indices and/or higher reliability value(s) or other rank parameter(s) for other bit indices for example, leads to lower code rates for corresponding blocks.

For example, a modified reliability ordered sequence may be particularly useful for applications involving rateless polar coding or incremental-redundancy (IR) HARQ. Relative to an original reliability ordered sequence such as that adopted for 5G, the indices of certain subchannels in a modified reliability ordered sequence are moved lower (in a sequence in order of increasing reliability) or higher (in a sequence in order of decreasing reliability), meaning that they will be regarded as less reliable. Such indices may be moved to the front of a sequence in order of increasing reliability or the end of a sequence in order of decreasing reliability, for example. This is only one option, and indices need not necessarily be moved to the front or end of a sequence.

For example, suppose that an original ascending reliability ordered sequence is Q=[1, 2, 3, 5, 4, 6, 7, 8], where u₄ is more reliable than u₅. However, the actual reliability of u₄ may be artificially reduced by moving it in front of u₅ in the following modified sequence:

$${Q}^{′} = [ 1 , 2 , 3 , 4 , 5 , 6 , 7 , 8 ] .$$

For sequence modifications, the indices or subchannels with reduced reliability can be chosen according to the following:

In the later part of v-code. If initial transmitted bits fall into bit indices [N/2+1, N/2+2, . . . , N] (sometimes referred to as u-code), then retransmitted bits fall into bit indices [1, 2, . . . , N/2] (sometimes referred to as v-code). Then, subchannels or bit indices [N/4+1, N/4+2, . . . , N/2] will have reduced (or equal) reliability and subchannels or bit indices [1, 2, . . . , N/4] will have increased (or equal) reliability.

In the earlier transmitted part of v-code. If initial transmitted bits fall into bit indices [N/2+1, N/2+2, . . . , N], or u-code, then retransmitted bits fall into bit indices [1, 2, . . . , N/2], or v-code. Then, subchannels or bit indices [t(1), t(2), . . . , t(N/4)] will have reduced (or equal) reliability, and subchannels or bit indices [t(N/4+1), t(N/4+2), . . . , t(N/2)] will have increased (or equal) reliability. Here, t(·) is a bit index in transmission order in v-code, for example, t(i) is the index of the i-th transmitted bit in v-code.

In some embodiments, multiple reliability ordered sequences may be used for different cases. For example, different reliability ordered sequences may be used based on the number of retransmissions in HARQ, or based on the ultimate overall transmission length (which may be bounded by the maximum size of a rate matching buffer).

A single reliability ordered sequence may instead be used, and may be designed with consideration of constructing rateless polar codes, or supporting IR-HARQ capabilities, for example.

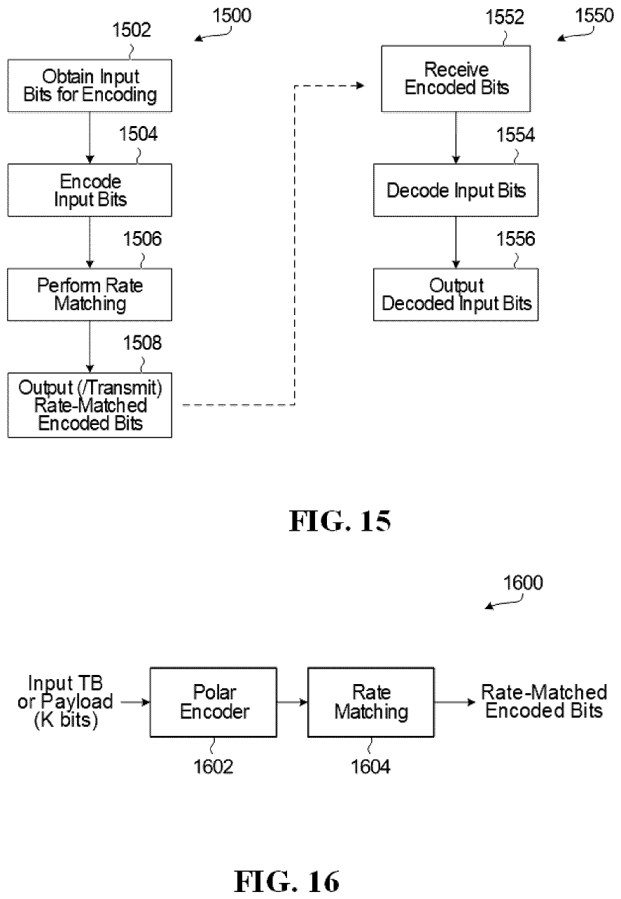

Various aspects of the present disclosure are described above and shown in the drawings by way of example. FIG. 15 is a flow diagram illustrating more general example methods according to embodiments. At the left, 1500 in FIG. 15 illustrates operations or features that may be provided or supported at an encoder or transmitter-side device, and at the right, 1550 illustrates operations or features that may be provided or supported at a decoder or receiver-side device. For ease of reference, in the following description of FIG. 15, a device at which encoding and/or transmitting features may be implemented or supported is called a first communication device, and a device at which decoding and/or receiving features may be implemented or supported is called a second communication device. Embodiments may involve either or both of such devices.

With reference first to 1500, from a transmitting device perspective the outputting of encoded bits may involve transmitting the encoded bits at 1508. Encoded bits may be output through or via any of various types of interface, including a communication interface in the case of transmitting the encoded bits. Embodiments are not in any way restricted to any particular type of interface. The encoded bits may be transmitted at 1508 by a first communication device to a second communication device in a wireless communication network, for example. The encoded bits are obtained by encoding input bits by a polar code at 1504, and may be referred to as encoded bits encoded by the polar code. Encoding at 1504 may be implemented or performed by an encoder or a processor, for example.

A polar code comprises or provides bit indices for placing values of input bits before encoding. The bit indices include a first set of bit indices for placing values of the input bits, a second set of bit indices for placing a predetermined bit value, and a third set of bit indices corresponding to a first segment of encoded bit indices of the encoded bits. The first segment is one of multiple unique segments of encoded bit indices of the encoded bits, and each segment of the encoded bit indices includes fewer than all encoded bit indices of all of the encoded bits.

Regarding these sets of bit indices, with reference to FIG. 11 the information set (marked “I” at the left of each trellis in FIG. 11) is an example of the first set, and the frozen set (marked “F” at the left of each trellis in FIG. 11) is an example of the second set. The third set refers to a set of bit indices (at the left of each trellis) corresponding to a segment of encoded bit indices, related to nodes at the right of each trellis. Segments Sᵢ and S₂ are sets of bit indices (1-8 in Sᵢ and 9-16 in S₂) that respectively correspond to encoded bit indices 1-8 and 9-16 in two unique segments of encoded bit indices that include fewer than all of the encoded bit indices (1-16) of all of the encoded bits. There are two segments of encoded bit indices, including encoded bit indices 1-8 and 9-16, respectively, to which the segments Sᵢ and S₂ of bit indices of the polar code correspond.

For code rate reduction, the second set and the third set of bit indices include at least a first bit index on which the predetermined bit value is placed to reduce a code rate of the first segment of the encoded bit indices. With reference again to FIG. 11, after code rate reduction the second set of bit indices (the frozen set) and the third set of bit indices (in segment S₁) both include bit index 4, illustrating overlap between the frozen set and the punctured (third) set of bit indices.

Bit value placement on bit indices is not shown separately in FIG. 15, and may be considered to be part of the encoding at 1504.

Rate matching may be performed at 1506, by an encoder or a rate matching module for example, to reduce the number of encoded bits on the bit indices in the first segment of the encoded bit indices of the encoded bits. In FIG. 11, rate matching is illustrated by way of example as puncturing at encoded bit indices 1 and 2 (in the first segment of encoded bit indices 1-8) at the right of each trellis. More generally, reducing the number of encoded bits may involve puncturing, shortening, or other operations to reduce the number of encoded bits for output.

Reducing the number of encoded bits need not change the number of encoded bits that are obtained by the encoding at 1504. Input bits are encoded to obtain encoded bits, and the number of encoded bits is subsequently reduced, by performing the rate matching at 1506 in the example shown in FIG. 15. The fact that the number of encoded bits, for transmission or output in some other way at 1508, is reduced does not change the number of encoded bits obtained by the encoding at 1504. For example, reduction in the number of encoded bits at 1506 does not reduce the number of encoded bits obtained for a codeword at the right of each trellis in FIG. 11.

Another operation that may be involved in a method according to some embodiments is illustrated at 1502. Obtaining input bits for encoding may involve, for example, collecting or otherwise receiving data outputs from one or more devices and/or services, or accessing data in a memory.

As shown at 1508, a method may also involve outputting the reduced number of encoded bits. The reduced number of encoded bits that remain after reducing the number of encoded bits at 1506 may be output for storage to memory, and/or transmission, for example.

Embodiments may include any or all of the operations illustrated at 1500. For example, in some embodiments, a method may involve encoding as shown at 1504, reducing the number of encoded bits at 1506, and transmitting or otherwise outputting the reduced number of encoded bits at 1508. Other embodiments may involve transmitting or otherwise outputting, at 1508, a reduced number of encoded bits that have already been obtained by encoding input bits by a polar code. Such embodiments are not mutually exclusive, and methods may involve the obtaining, encoding, and rate matching at 1502, 1504, 1506, and also outputting encoded bits as shown at 1508.

Features may be implemented in any of various ways, and/or other features may also or instead be provided or supported.

For example, reducing the number of encoded bits for output may involve reducing the code rate of the first segment of encoded bit indices by moving one or more bit indices from the first set (for placement of input bit values) to the second set (for the predetermined value. An example above referred to a first bit index that is included in both the second set and the third set of bit indices. In this context, the first bit index may be moved from the first set to the second set of bit indices to reduce the code rate of the first segment of encoded bit indices. The first bit index in this example was moved from the first set (e.g., an information set) to the second set (e.g., the frozen set), and is also in the third set (e.g., punctured set), so the code rate of the first segment of encoded bit indices, to which the third set corresponds, is reduced.

Some embodiments involve increasing the code rate of a non-punctured codeword segment. With reference again to FIG. 11, the segment S₂ corresponds to a second (non-punctured) segment of encoded bit indices 9-16. The segment S₂ is therefore an example of a fourth set of bit indices corresponding to a second segment of the multiple unique segments of the encoded bit indices. The first set (e.g., information set, for bit values of input bits) and the fourth set of bit indices both include at least one bit index, which may be referred to as a second bit index, on which a value of an input bit is placed to increase a code rate of the second segment of the encoded bit indices. In FIG. 11, a value of an input bit is placed on bit index 9 at the left of the right-hand trellis, and this bit index is now an information bit index instead of a frozen bit index. This increases the code rate of the second segment of encoded bit indices 9-16 relative to the code rate of this segment in the left-hand trellis.

Increasing the code rate of the second segment of the encoded bit indices, similar to decreasing the code rate of the first segment of the encoded bit indices, may involve moving one or more bit indices. Moving the above-referenced second bit index from the second set of bit indices (for the predetermined value) to the first set of bit indices (for input bit values) increases the code rate of the encoded bit index segment corresponding to the fourth set of bit indices. In the example shown in FIG. 11, the second bit index is bit index 9, and was moved from the second set (the frozen set) to the first set (the information set), and is also in the fourth set (the non-punctured set, segment S₂), so the code rate of the second segment of encoded bit indices 9-16, to which the fourth set corresponds, is increased.

The first set of bit indices for input bit values may include an information set and a parity check set. See FIG. 8, for example. In such an embodiment, a method may involve increasing the code rate of the second segment of the encoded bit indices by moving the second bit index from the parity check set to the information set. The bit value that is placed on a PC bit index is normally also placed on another bit index and is decodable for that other bit index, and therefore a PC bit normally does not count as an information bit in determining code rate. However, moving a bit index from a parity check set to an information set, as described by way of example at least above, results in a PC bit becoming or being treated as an information bit, which increases code rate.

Within this context of an information set and a parity check set, prior to increasing the code rate of the second segment, the third set of bit indices includes a bit index in the information set on which an input bit value is placed, and the fourth set of bit indices includes a bit index in the parity check set on which the same input bit value is also placed. In This is illustrated by way of example in FIG. 8. The third set includes bit indices 1 to N/2 at the left in each row, and the fourth set includes bit indices N/2+1 top N at the right in each row. In the second full row, FIG. 8 illustrates bit indices before increasing code rate. At that stage, the third set of bit indices (to the left) includes information bit indices on which respective bit values are placed, and the fourth set of bit indices (at the right) includes PC bit indices on which the same respective bit values are also placed. This is illustrative of an embodiment in which the third (left) set of bit indices includes a bit index in the information set on which an input bit value is placed, and the fourth (right) set of bit indices includes a bit index in the parity check set on which the same input bit value is also placed, before a code rate increase.

Even after a code rate increase, there may be a bit index in the third set and the information set on which an input bit value is placed, and a bit index in the fourth set and the parity check set on which the same input bit value is also placed. This is illustrated by way of example in the bottom row in FIG. 8, in which there are information bit indices in the third set of bit indices 1−N/2 and PC bit indices in the fourth set of bit indices N/2+1 to N, after a code rate increase.

These features also hold before and after a decrease in code rate of the encoded bit index segment corresponding to the third set of bit indices, which includes the bit indices 1−N/2 in FIG. 8.

Several examples herein refer to a punctured segment such as Sᵢ and a non-punctured segment such as Sⱼ, wherein i and j are each intended to generally designate a segment. Embodiments are not limited only to one punctured and one non-punctured segment or set of bit indices, or to respective corresponding segments or sets of encoded bit indices from which encoded bits are or are not punctured. There may be multiple third sets of bit indices that correspond to respective first segments of encoded bit indices from which the number of encoded bits is reduced, and/or multiple fourth sets of bit indices that correspond to respective second segments of encoded bit indices on which encoded bits are not reduced. In FIG. 8, for example, two third sets may include bit indices 1 to N/4 and bit indices N/4+1 to N/2, respectively, and correspond to two first segments of encoded bit indices, including one segment of encoded bit indices 1 to N/4 and another segment of encoded bit indices N/4+1 to N/2, from each of which encoded bits are reduced. There may also or instead be two fourth sets that include bit indices N/2+1 to 3N/4 and bit indices 3N/4+1 to N, respectively, and correspond to two second segments of encoded bit indices N/2+1 to 3N/4 and encoded bit indices 3N/4+1 to N on which encoded bits are not reduced.

In this context, for code rate reduction, the second set and the third sets of bit indices include multiple first bit indices on which the predetermined bit value is placed to reduce a code rate of each of the first segments of the encoded bit indices. Prior to reducing the number of encoded bits from the first segments to reduce the code rate of the first segments, and prior to increasing the code rate of the second segments, the third (punctured) sets of bit indices include respective bit indices in the information set (these include at least the first bit indices referenced above) on which respective input bit values are placed or are to be placed, and the fourth sets of bit indices comprise bit indices in the parity check set on which the same respective input bit values are also placed. In other words, before code rate reduction and code rate increase, the same bit values may be placed on both information bit indices in punctured segments and PC bit indices in non-punctured segments. After code rate reduction, the bit indices on which those bit values were placed or were to be placed (referenced above as multiple first bit indices), are for placement of the predetermined bit value. After code rate increase, PC bit indices in the non-punctured segments become or are otherwise treated as information bit indices. This is consistent with the example shown in FIG. 8, but for multiple punctured and non-punctured segments or sets of bit indices corresponding to multiple punctured and non-punctured segments or sets of encoded bit indices.

An order of placing the input bit values on the respective bit indices in the third sets and the information set may be different from an order of placing the input bit values on the bit indices in the fourth sets and the parity check set, prior to reducing the code rate of the first segments and prior to increasing the code rate of the second segments. For example, consistent with embodiments disclosed elsewhere herein, the input bit values may be placed on the respective bit indices in the third sets and the information set by ascending (or descending) rank such as reliability order, and the input bit values may be placed on the bit indices in the fourth sets and the parity check set by descending (or ascending) rank such as reliability order. Other different orders are also possible.

In some embodiments, the third set of bit indices includes multiple unique parts, the fourth set of bit indices includes multiple unique parts, and each part of the third set of bit indices is associated with a respective part of the fourth set of bit indices. This is illustrated by way of example in FIGS. 9 and 10.

The pieces into which information bit indices are divided in FIGS. 9 and 10 are illustrative of the above-referenced third parts. In these drawings, the punctured segment Sᵢ is an example of a third set of bit indices, and the pieces into which the information bit indices in Sᵢ are divided are an example of parts of a third set of bit indices. Similarly, the non-punctured segment Sⱼ is an example of a fourth set of bit indices. As described elsewhere herein, newly-flagged information bit indices for Sⱼ, which are newly flagged as information bit indices from among frozen bit indices in FIG. 9 or from PC bit indices in FIG. 10, can be further divided into pieces of size ΔKᵢ₁, ΔKᵢ₂, ΔK_{iq} . . . ΔK_{iq}, and these pieces are illustrative of parts of a fourth set of bit indices. Bit values that are placed or were to be placed on information bit indices in the pieces for Sᵢ may be placed on the information bit indices in the q pieces in Sⱼ one-by-one, sequentially, and in at least this sense each part of the third set of bit indices (e.g., each piece in Sᵢ in FIGS. 9 and 10) is associated with a respective part of the fourth set of bit indices (e.g., each piece in Sⱼ in FIGS. 9 and 10).

For code rate reduction, the second set of bit indices and each part of the third set of bit indices includes a respective first bit index, or more generally one or more bit indices, on which the predetermined bit value is placed to reduce a code rate of a respective part of the first segment of the encoded bit indices corresponding to each part of the third set of bit indices. The respective first bit indices that are in both the second set and each part of the third set of bit indices are shown by way of example as reduced information bits in FIGS. 9 and 10.

Some embodiments may involve increasing code rate. For example, the first set and each part of the fourth set of bit indices may include a respective second bit index on which a value of an input bit is placed to increase a code rate of a respective part of the second segment of the encoded bit indices corresponding to each part of the third set of bit indices. The respective second bit indices that are in both the first set and each part of the fourth set of bit indices are shown by way of example as added information bits in FIG. 9, and as bits that are no longer PC bits in FIG. 10.

FIG. 9 illustrates an embodiment in which the respective second bit indices in the first set and each part of the fourth set of bit indices include bit indices that would otherwise have been frozen bit indices were it not for an increase in code rate. These bit indices may be moved from the second set (for the predetermined value) into the first set (for bit values of input bits), but as disclosed elsewhere herein moving bit indices between sets is only one possible way to change code rate.

The first set of bit indices referenced above may include an information set and a parity check set, in which case the respective second bit indices in the first set and each part of the fourth set of bit indices may include bit indices that would otherwise have been in the parity check set were it not for an increase in code rate. These bit indices may be moved from the parity check set into the information set, as shown by way of example in FIG. 10. Again, moving bit indices between sets is only one possible way to change code rate, and the present disclosure is not in any way limited to changing code rate by moving bit indices between sets.

FIGS. 9 and 10 illustrate two re-order operations related to each of Sᵢ and Sⱼ. In FIGS. 9 and 10, Re-order 1 illustrates that the information bit indices in Sᵢ may be re-ordered into a different order before they are divided into pieces or parts. Similarly, Re-order 2 in FIG. 9 illustrates that the frozen bit indices in Sⱼ may be re-ordered into a different order before they are divided into pieces or parts, and Re-order 2 in FIG. 10 illustrates that the PC bit indices in Sⱼ may be re-ordered into a different order before they are divided into pieces or parts. Bit indices in each piece or part may also or instead be re-ordered into a different order, as shown by Re-order above each of the last rows of bit indices in FIGS. 9 and 10. Any or all of these operations may be applied independently. For example, information bit indices in Sᵢ may be re-ordered according as shown by Re-order 1, with or without applying re-ordering to frozen bit indices or PC bit indices as shown by Re-order 2. Regardless of whether or not bit indices are re-ordered according to Re-order 1 and/or Re-order 2, bit indices within each piece or part may be re-ordered, independently of any re-ordering in other pieces or parts. In the context of the above-referenced parts of the third and fourth sets of bit indices, the bit indices in each part of the third set of bit indices (e.g., the pieces into which the information bit indices in Sᵢ are divided in FIGS. 9 and 10) may be re-ordered and in a different order relative to an order of the bit indices in the third set, and the bit indices in each part of the fourth set of bit indices (e.g., the pieces into which the frozen bit indices in Sⱼ in FIG. 9 or the PC bit indices in Sⱼ in FIG. 10 are divided) may also or instead be in a different order relative to an order of the bit indices in the fourth set.

In general, bit indices in different sets or segments may be in different orders. For example, each of multiple sets of bit indices that respectively correspond to different unique segments of encoded bit indices may include consecutive bit indices in a sequential order of the bit indices, or consecutive bit indices in an interleaved order of the bit indices. In the latter example, the interleaved order of the bit indices corresponding to an interleaved order of the encoded bits for reducing the number of the encoded bits.

Reducing the number of encoded bits may be according to a rate matching operation in some embodiments. For example, an amount of code rate reduction by which the code rate of the first segment of the encoded bit indices is reduced may be based on one or more parameters. The one or more parameters may include any one or more of: a target code rate associated with the rate matching operation, the code rate of the second (non-punctured) segment, a puncturing ratio associated with the rate matching operation, and a puncturing pattern associated with the rate matching operation. A rate matching operation may involve puncturing, shortening, repetition, or combinations thereof, and interleaving may also be applied in conjunction with rate matching.

Regarding code rate reduction based on an original code rate of a non-punctured segment, generally the higher the original code rate of a non-punctured segment, the less code rate reduction can be applied. This is because a higher original code rate of a non-punctured segment limits how much the partial code rate of that segment can be increased to compensate for lowering the partial code rate of a punctured segment.

More generally, to reduce code rate, a code rate reduction may be code rate-dependent, puncture-dependent based on puncturing for rate matching, or jointly rate-and-puncture-dependent. Examples of a code rate-dependent code rate reduction ratio α_{R} are provided elsewhere herein, and include the following, defined as a function of a code rate: α_{R} being a monotonically increasing function of a code rate, α_{R} being equal to a code rate, α_{R} being equal to a code rate multiplied by a constant such as 1/8, 1/4, 3/8, 1/2, 5/8, 3/4, 7/8, and α_{R} consistent with other functions of a code rate or otherwise dependent upon a code rate. Examples of a puncture-dependent code rate reduction ratio α_{P} are also provided elsewhere herein, and include the following: a monotonically decreasing function of a punctured length such as a total punctured length P=N−M or punctured length Pᵢ of a punctured segment, a function, α_{P}=N/(c_{α}·P+N) where c_{α} is a predefined constant such as 2, 4, 8, 16, 32, 64, 128, 256, α_{P}=d_{α}·N/(c_{α}·P+N) where d_{α} is another predefined constant such as 1/8, 1/4, 3/8, 1/2, 5/8, 3/4, 7/8, and the latter two example functions with P substituted with Pᵢ. Regarding hybrid or jointly-dependent embodiments, examples of a joint rate-and-puncture-dependent code rate reduction ratio α include a determined as a function, such as a product, of α_{R} and α_{P}: α=α_{R}·α_{P}.

Another method related to encoding may involve encoding input bits by a polar code to obtain a number of encoded bits and outputting a reduced number of the encoded bits, as described in detail elsewhere herein and shown by way of example at 1704, 1708 in FIG. 17. The polar code, as in other embodiments, comprises bit indices for placing values of the input bits before encoding, and the bit indices include a first set of bit indices for the values of the input bits and a second set of bit indices for a predetermined bit value. The encoded bits include a subset that includes fewer than all of the encoded bits and is for reducing the number of the encoded bits.

Features disclosed herein may also or instead be embodied in other forms. An ordered sequence of polar code bit indices, for example, may embody, or be modified to embody, features related to partial interleaving and/or information bit recycling as disclosed herein.

According to an embodiment, a method involves obtaining an ordered sequence indicating a plurality of bit indices for a polar code in an order of rank (by reliability for example) for placing values of input bits for encoding by the polar code to obtain a number of encoded bits. The order of rank indicated by the ordered sequence is for reducing the number of the encoded bits. The bit indices include: a first set of bit indices of highest rank according to the ordered sequence, for placing the values of the input bits; a second set of bit indices of lower rank than the highest rank according to the ordered sequence, for placing a predetermined bit value; and a third set of bit indices corresponding to a first segment of encoded bit indices of the encoded bits. Such a method may also involve encoding the input bits by the polar code according to the ordered sequence, to obtain the number of encoded bits at 1504 for example; reducing a number of the encoded bits on the bit indices in the first segment of the encoded bit indices of the encoded bits at 1506 for example; and outputting the reduced number of the encoded bits at 1508 for example. Other features disclosed herein may also or instead be provided or supported in such a method.

The second set and the third set of bit indices include a first bit index on which the predetermined bit value is to be placed to reduce a code rate of the first segment of the encoded bit indices. The first segment is one of a plurality of unique segments of encoded bit indices of the encoded bits, and each segment of the encoded bit indices includes fewer than all of the encoded bit indices of all of the encoded bits. Thus, the order of rank and the bit indices in each set are determined based on how the number of encoded bits is to be reduced in order to reduce code rate of the first segment, or more generally code rate(s) of one or more segments of encoded bit indices. Rank in an ordered sequence and/or bit indices in one or more sets may take into account an increase code rate(s) of one or more other segments of encoded bit indices.

Obtaining an ordered sequence may involve selecting from a number of available ordered sequences. For example, ordered sequences for different mother code lengths, transmitted code lengths, puncturing patterns, etc., may be pre-generated and specified in a communication standard or specification, and then selected for use in encoding based on encoding parameters or conditions. Another possible option for obtaining an ordered sequence involves modifying a base sequence that indicates the bit indices for the polar code in a base order of rank for placing the values of input bits for encoding by the polar code to obtain the number of encoded bits, and the base order of rank is for outputting the number of the encoded bits. In other words, a base sequence that does not take encoded bit reduction into account may be modified to obtain a sequence in which order of rank of bit indices, and thus the bit indices in each set, for reducing the number of the encoded bits in order to change (reduce and/or increase) code rate of one or more segments of encoded bit indices of the encoded bits. A communication standard or specification may specify one or more base sequences, and possibly instructions for modifying the base sequence(s) according to encoding parameters or conditions. A reliability sequence Q=[Q₁, Q₂ . . . . Q_{N}], indicating bit indices in ascending reliability order, is an example of a base sequence.

At 1550, FIG. 15 illustrates various decoding and/or receiving counterparts of features shown at 1500. From a receiving device perspective, the receiving at 1552 represents receiving a reduced number of encoded bits that have been encoded by a polar code. The receiving at 1552 may involve receiving the encoded bits from a first communication device by a second communication device in a wireless communication network, for example. Encoded bits may be received through or via any of various types of interface, and embodiments are not in any way restricted to any particular type of interface.

The polar code, as in other embodiments herein, comprises bit indices for placing values of input bits, and the bit indices comprise a first set of bit indices for the values of the input bits, a second set of bit indices for a predetermined bit value, and a third set of bit indices corresponding to a first segment of a plurality of unique segments of encoded bit indices of the encoded bits. Each segment of the encoded bit indices includes fewer than all encoded bit indices of all of the encoded bits, and the second set and the third set of bit indices comprise a first bit index on which the predetermined bit value is placed to reduce a code rate of the first segment of the encoded bit indices.

The decoding at 1554 is intended to illustrate decoding the received reduced number of encoded bits to obtain decoded input bits. Decoding at 1554 may be implemented or performed by a decoder or a processor, for example.

In some embodiments, a decoder might not be a discrete device, but rather a block of logic in silicon or part of a system-on-chip that decodes and uses the decoded input bits. In other embodiments, the decoded input bits are output as shown at 1556, for processing and/or storage, for example.

Any or all of the features that are described herein in the context of encoder-side or transmitter-side methods, with reference to operations at 1500 in FIG. 15, for example, may also apply to or have counterpart features in a decoder-side or receiver-side method. Any one or more of the following features, for example, may be provided or supported, individually or in any of various combinations, in a decoder-side or receiver-side method:
the first bit index was moved from the first set of bit indices to the second set of bit indices;
the bit indices further comprise a fourth set of bit indices corresponding to a second segment of the plurality of unique segments of encoded bit indices, with the first set and the fourth set of bit indices comprising a second bit index on which a value of an input bit is placed to increase a code rate of the second segment of the encoded bit indices;
the second bit index was moved from the second set of bit indices into the first set of bit indices;
the first set comprises an information set and a parity check set;
the second bit index was moved from the parity check set to the information set;
before the code rate of the second segment was increased, the third set of bit indices may comprise a bit index in the information set on which an input bit value is placed and the fourth set of bit indices may comprise a bit index in the parity check set on which the same input bit value is also placed;
the bit indices comprise a plurality of third sets of bit indices that correspond to respective first segments of the encoded bit indices from which the number of encoded bits is reduced, and a plurality of fourth sets of bit indices that correspond to respective second segments of the encoded bit indices on which encoded bits are not reduced with the second set and the third sets of bit indices comprising a plurality of first bit indices on which the predetermined bit value is placed to reduce a code rate of each of the first segments of the encoded bit indices and before the code rate of the second segments was increased, the third sets of bit indices further comprising respective bit indices in the information set on which respective input bit values are placed and the fourth sets of bit indices comprising bit indices in the parity check set on which the same respective input bit values are also placed;
an order of placing the input bit values on the respective bit indices in the third sets and the information set is different from an order of placing the input bit values on the bit indices in the fourth sets and the parity check set;
the third set of bit indices comprises a plurality of unique parts, the fourth set of bit indices comprises a plurality of unique parts, and each part of the third set of bit indices is associated with a respective part of the fourth set of bit indices, with the second set and each part of the third set of bit indices comprising a respective first bit index on which the predetermined bit value is placed to reduce a code rate of a respective part of the first segment of the encoded bit indices corresponding to each part of the third set of bit indices, and the first set and each part of the fourth set of bit indices comprising a respective second bit index on which a value of an input bit is placed to increase a code rate of a respective part of the second segment of the encoded bit indices corresponding to each part of the fourth set of bit indices;
the respective second bit indices in the first set and each part of the fourth set of bit indices comprise bit indices moved from the second set into the first set;
with the first set of bit indices comprising an information set and a parity check set, the respective second bit indices in the first set and each part of the fourth set of bit indices may comprise bit indices moved from the parity check set into the information set;
the bit indices in each part of the third set of bit indices are in a different order relative to an order of the bit indices in the third set;
the bit indices in each part of the fourth set of bit indices are in a different order relative to an order of the bit indices in the fourth set;
the number of the encoded bits have been reduced according to a rate matching operation;
an amount of rate reduction by which the code rate of the first segment of the encoded bit indices was reduced is based on one or more parameters;
the one or more parameters include any one or more of: a target code rate associated with the rate matching operation, the code rate of the second segment, a puncturing ratio associated with the rate matching operation, and a puncturing pattern associated with the rate matching operation;
each of a plurality of sets of the bit indices that respectively correspond to the plurality of unique segments of encoded bit indices of the encoded bits comprises consecutive bit indices in a sequential order of the bit indices, or consecutive bit indices in an interleaved order of the bit indices, the interleaved order of the bit indices corresponding to an interleaved order of the encoded bits for reducing the number of the encoded bits;
to reduce the code rate, a code rate reduction is code rate-dependent, puncture-dependent based on puncturing for rate matching, or jointly rate-and-puncture-dependent;
the receiving involves receiving the reduced number of encoded bits from a first communication device by a second communication device in a wireless communication network.

A sequence-based approach, described in an example above from an encoding perspective, may have counterpart receiving, decoding, and other features. A method may involve receiving a reduced number of encoded bits encoded by a polar code, with the polar code comprising bit indices for placing values of input bits, and the bit indices comprising: a first set of bit indices of highest rank according to an ordered sequence, for placing the values of the input bits before encoding; a second set of bit indices of lower rank than the highest rank according to the ordered sequence, for a predetermined bit value; and a third set of bit indices corresponding to a first segment of encoded bit indices of the encoded bits. The order of rank is for reducing the number of the encoded bits, and the second set and the third set of bit indices comprise a first bit index on which the predetermined bit value is to be placed to reduce a code rate of the first segment of the encoded bit indices. The first segment is one of multiple unique segments of encoded bit indices of the encoded bits, and each segment of the encoded bit indices includes fewer than all of the encoded bit indices of all of the encoded bits. Such a method may also involve decoding the reduced number of encoded bits to obtain decoded input bits. A sequence-based method of this type is also consistent with a method shown in FIG. 15, including receiving at 1552 and decoding at 1554.

The ordered sequence in this example may have been obtained by selecting from among available sequences, or may have been obtained by modifying a base sequence. The base sequence may indicate the bit indices for the polar code in a base order of rank for placing the values of input bits for encoding by the polar code to obtain the number of encoded bits, with the base order of rank being for outputting the number of the encoded bits rather than the reduced number of the encoded bits.

Embodiments may involve other features or operations as well. For example, some embodiments may involve communicating signaling that is indicative of any of various parameters, such as any one or more of: code length, code rate, puncturing pattern, base sequence, etc. Communicating of signaling may involve transmitting the signaling by an encoder/encoding device or a transmitter/transmitting device that is to transmit encoded bits, to a decoder/decoding device or a receiver/receiving device. The communicating may also or instead involve receiving the signaling by a decoder/decoding device or a receiver/receiving device from an encoder/encoding device or a transmitter/transmitting device. Signaling need not necessarily be between, or only between, communication devices by which encoded bits are to be transmitted or received. For example, a network device such as a gNB or a base station may transmit signaling to configure parameters at one or more communication devices. Therefore, a method may involve a network device transmitting signaling, and an encoder/encoding device or a transmitter/transmitting device receiving the signaling from the network device, and/or a decoder/decoding device or a receiver/receiving device receiving the signaling from the network device.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor that is configured, by executing programming for example, to cause the apparatus to perform a method or operations, or to provide or support features, disclosed herein. An apparatus may also include a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to or to cause a processor to encode input bits by a polar code to obtain a number of encoded bits, with the polar code comprising bit indices for placing values of the input bits before encoding. The bit indices comprise a first set of bit indices for the values of the input bits, a second set of bit indices for a predetermined bit value, and a third set of bit indices corresponding to a first segment of a plurality of unique segments of encoded bit indices of the encoded bits. As in other embodiments, each segment of the encoded bit indices includes fewer than all encoded bit indices of all of the encoded bits, and the second set and the third set of bit indices comprise a first bit index on which the predetermined bit value is placed to reduce a code rate of the first segment of the encoded bit indices. Programming may also include instructions to or to cause a processor to reduce a number of the encoded bits on the bit indices in the first segment of the encoded bit indices of the encoded bits. In some embodiments, programming also includes instructions to or to cause a processor to output the reduced number of the encoded bits.

According to another programming embodiment, programming includes instructions to or to cause a processor to obtain an ordered sequence and encode input bits by a polar code according to the ordered sequence to obtain a number of encoded bits. The ordered sequence indicates a plurality of bit indices for the polar code in an order of rank for placing values of the input bits for encoding by the polar code, and the bit indices comprise: a first set of bit indices of highest rank according to the ordered sequence, for placing the values of the input bits; a second set of bit indices of lower rank than the highest rank according to the ordered sequence, for a predetermined bit value; and a third set of bit indices corresponding to a first segment of encoded bit indices of the encoded bits. The order of rank is for reducing the number of the encoded bits. The second set and the third set of bit indices comprise a first bit index on which the predetermined bit value is to be placed to reduce a code rate of the first segment of the encoded bit indices, and the first segment is one of a plurality of unique segments of encoded bit indices of the encoded bits. Each segment of the encoded bit indices includes fewer than all of the encoded bit indices of all of the encoded bits. In a sequence-based embodiment, programming may also include instructions to or to cause a processor to reduce a number of the encoded bits on the bit indices in the first segment of the encoded bit indices of the encoded bits, and programming may include instructions to or to cause a processor to output the reduced number of the encoded bits as well.

Apparatus embodiments are not limited to the foregoing examples of programming-based embodiments. An apparatus may also or instead include, for example: an encoder for encoding input bits by a polar code to obtain encoded bits; a rate matching module coupled to the encoder, for reducing a number of the encoded bits; and an interface coupled to the rate matching module, for outputting the reduced number of the encoded bits. As in other embodiments, the polar code comprises bit indices for placing values of the input bits before encoding, the bit indices comprise: a first set of bit indices for the values of the input bits, a second set of bit indices for a predetermined bit value, and a third set of bit indices corresponding to a first segment of a plurality of unique segments of encoded bit indices of the encoded bits, each segment of the encoded bit indices includes fewer than all encoded bit indices of all of the encoded bits, and the second set and the third set of bit indices comprise a first bit index on which the predetermined bit value is placed to reduce a code rate of the first segment of the encoded bit indices.

FIG. 16 is a block diagram illustrating an apparatus in which such an embodiment may be implemented or supported. The example apparatus 1600 includes a polar encoder 1602 and a rate matching module 1604 coupled to the polar encoder. Input bits for encoding are shown as input TB or payload bits, and rate-matched encoded bits are shown as an output of the rate matching module 1604. An interface for transmitting or otherwise outputting the reduced number of encoded bits may be provided by, incorporated into, or coupled to, any one or more of the polar encoder 1602 and the rate matching module 1604.

Encode-side or transmit-side features or functions, and other features or functions herein, may be implemented in any of various ways, such as in hardware, firmware, or one or more components that execute software. The present disclosure is not limited to any specific type of implementation, and implementation details may vary between different devices, for example.

In the example apparatus 1600, the polar encoder 1602 is configured, by executing software for example, to encode (or for encoding) bits to obtain encoded bits. The rate matching module 1604 is configured, by executing software for example, to reduce (or for reducing) the number of encoded bits, by performing rate matching in this example, and may include a circular buffer for storing encoded bits from the polar encoder 1602.

The apparatus 1800 is intended purely as an illustrative example. Embodiments are not in any way limited to implementation in the manner shown. Apparatus embodiments may include fewer, additional, and/or different components.

More generally, an apparatus or a component thereof such as an encoder 1602 or a processor may be configured to encode (or for encoding) input bits, or programming may include instructions to encode (or for encoding) input bits or to cause a processor to encode input bits, to obtain a number of encoded bits. In some embodiments, an apparatus or a component thereof such as a rate matching module 1604 or a processor may be configured to reduce (or for reducing), or programming may include instructions to or to cause a processor: to reduce, a number of the encoded bits on bit indices in a first segment of encoded bit indices of the encoded bits.

Such an apparatus or a component thereof such as an interface may be configured to output (or for outputting), or programming may include instructions to output (or for outputting) or to cause a processor to output, the reduced number of encoded bits, such as by transmitting the reduced number of encoded bits by a first communication device to a second communication device in a wireless communication network for example.

Embodiments related to such apparatus or non-transitory computer readable storage media may include any one or more of the following features, for example, which are also discussed elsewhere herein:
the apparatus or a component thereof such as a rate matching module 1604 may be configured to reduce (or for reducing), or programming may include instructions to reduce (or for reducing) or to cause a processor to reduce, the number of the encoded bits by reducing the code rate of the first segment of the encoded bit indices by moving the first bit index from the first set of bit indices to the second set of bit indices;
the bit indices further comprise a fourth set of bit indices corresponding to a second segment of the plurality of unique segments of encoded bit indices, with the first set and the fourth set of bit indices comprising a second bit index on which a value of an input bit is placed to increase a code rate of the second segment of the encoded bit indices;
the apparatus or a component thereof such as a rate matching module 1604 may be configured to increase (or for increasing), or programming may include instructions to increase (or for increasing) or to cause a processor to increase, the code rate of the second segment of the encoded bit indices by moving the second bit index from the second set of bit indices to the first set of bit indices;
the first set of bit indices comprises an information set and a parity check set, and the apparatus or a component thereof such as a rate matching module 1604 may be configured to increase (or for increasing), or programming may include instructions to increase (or for increasing) or to cause a processor to increase, the code rate of the second segment of the encoded bit indices by moving the second bit index from the parity check set to the information set;
prior to the code rate of the second segment being increased, the third set of bit indices comprises a bit index in the information set on which an input bit value is placed, and the fourth set of bit indices comprises a bit index in the parity check set on which the same input bit value is also placed;
the bit indices comprise a plurality of third sets of bit indices that correspond to respective first segments of the encoded bit indices from which the number of encoded bits is reduced, and a plurality of fourth sets of bit indices that correspond to respective second segments of the encoded bit indices on which encoded bits are not reduced, the second set and the third sets of bit indices comprise a plurality of first bit indices on which the predetermined bit value is placed to reduce a code rate of each of the first segments of the encoded bit indices, and prior to the code rate of the second segments being increased, the third sets of bit indices further comprise respective bit indices in the information set on which respective input bit values are placed, and the fourth sets of bit indices comprise bit indices in the parity check set on which the same respective input bit values are also placed;
an order of placing the input bit values on the respective bit indices in the third sets and the information set is different from an order of placing the input bit values on the bit indices in the fourth sets and the parity check set;
the third set of bit indices comprises a plurality of unique parts, the fourth set of bit indices comprises a plurality of unique parts, and each part of the third set of bit indices is associated with a respective part of the fourth set of bit indices, the second set and each part of the third set of bit indices comprises a respective first bit index on which the predetermined bit value is placed to reduce a code rate of a respective part of the first segment of the encoded bit indices corresponding to each part of the third set of bit indices, and the first set and each part of the fourth set of bit indices comprises a respective second bit index on which a value of an input bit is placed to increase a code rate of a respective part of the second segment of the encoded bit indices corresponding to each part of the fourth set of bit indices;
the respective second bit indices in the first set and each part of the fourth set of bit indices comprise bit indices moved from the second set into the first set;
with the first set of bit indices comprising an information set and a parity check set, the respective second bit indices in the first set and each part of the fourth set of bit indices comprise bit indices moved from the parity check set into the information set;
the bit indices in each part of the third set of bit indices are in a different order relative to an order of the bit indices in the third set;
the bit indices in each part of the fourth set of bit indices are in a different order relative to an order of the bit indices in the fourth set;
the apparatus or a component thereof such as a rate matching module 1604 may be configured to reduce (or for reducing), or programming may include instructions to reduce (or for reducing) or to cause a processor to reduce, the number of the encoded bits according to a rate matching operation,
an amount of rate reduction by which the code rate of the first segment of the encoded bit indices is reduced is based on one or more parameters;
the one or more parameters include any one or more of: a target code rate associated with the rate matching operation, the code rate of the second segment, a puncturing ratio associated with the rate matching operation, and a puncturing pattern associated with the rate matching operation;
each of a plurality of sets of the bit indices that respectively correspond to the plurality of unique segments of encoded bit indices of the encoded bits comprises consecutive bit indices in a sequential order of the bit indices, or consecutive bit indices in an interleaved order of the bit indices, the interleaved order of the bit indices corresponding to an interleaved order of the encoded bits for reducing the number of the encoded bits;
to reduce the code rate, a code rate reduction is code rate-dependent, puncture-dependent based on puncturing for rate matching, or jointly rate-and-puncture-dependent;
the apparatus or a component thereof such as an interface may be configured to transmit (or for transmitting), or programming may include instructions to transmit (or for transmitting) or to cause a processor to transmit, the reduced number of encoded bits from a first communication device to a second communication device in a wireless communication network.

In another apparatus embodiment, an apparatus includes an encoder such as 1602 for obtaining an ordered sequence and encoding input bits by a polar code according to the ordered sequence to obtain a number of encoded bits; a rate matching module such as 1604 coupled to the encoder, for reducing a number of the encoded bits on the bit indices in a first segment of the encoded bit indices of the encoded bits; and an interface coupled to the rate matching module, for outputting the reduced number of the encoded bits. The ordered sequence indicates a plurality of bit indices for the polar code in an order of rank for placing values of the input bits for encoding by the polar code, and the bit indices comprise: a first set of bit indices of highest rank according to the ordered sequence, for placing the values of the input bits; a second set of bit indices of lower rank than the highest rank according to the ordered sequence, for a predetermined bit value; and a third set of bit indices corresponding to the first segment of encoded bit indices of the encoded bits. The order of rank is for reducing the number of the encoded bits, the second set and the third set of bit indices comprise a first bit index on which the predetermined bit value is to be placed to reduce a code rate of the first segment of the encoded bit indices, and the first segment is one of a plurality of unique segments of encoded bit indices of the encoded bits. Each segment of the encoded bit indices including fewer than all of the encoded bit indices of all of the encoded bits.

In some embodiments, the apparatus or a component thereof such as the encoder 1602 may be configured to obtain (or for obtaining), or programming may include instructions to obtain (or for obtaining) or to cause a processor to obtain, the ordered sequence by modifying a base sequence. The base sequence indicates the plurality of bit indices for the polar code in a base order of rank for placing the values of input bits for encoding by the polar code to obtain the number of encoded bits, and the base order of rank is for outputting the number of the encoded bits.

For a decoder-side or receiver-side apparatus or a computer program product comprising a non-transitory computer readable storage medium to support decoder-side or receiver-side operations, the apparatus or a component thereof such as an interface may be configured to receive (or for receiving), or programming may include instructions to receive (or for receiving) or to cause a processor to receive, a reduced number of encoded bits that have been encoded by a polar code. Such an apparatus or a component thereof such as a decoder may be configured to decode (or for decoding), or programming may include instructions to decode (or for decoding) or to cause a processor to decode, the reduced number of encoded bits to obtain decoded input bits. As in other embodiments, the polar code comprises bit indices for placing values of input bits, the bit indices comprise: a first set of bit indices for the values of the input bits, a second set of bit indices for a predetermined bit value, and a third set of bit indices corresponding to a first segment of a plurality of unique segments of encoded bit indices of the encoded bits, each segment of the encoded bit indices includes fewer than all encoded bit indices of all of the encoded bits, and the second set and the third set of bit indices comprise a first bit index on which the predetermined bit value is placed to reduce a code rate of the first segment of the encoded bit indices.

Embodiments related to such apparatus or non-transitory computer readable storage media may include any one or more of the following features, for example, which are also discussed elsewhere herein:
the first bit index was moved from the first set of bit indices to the second set of bit indices;
the bit indices further comprise a fourth set of bit indices corresponding to a second segment of the plurality of unique segments of encoded bit indices, with the first set and the fourth set of bit indices comprising a second bit index on which a value of an input bit is placed to increase a code rate of the second segment of the encoded bit indices;
the second bit index was moved from the second set of bit indices into the first set of bit indices;
the first set comprises an information set and a parity check set, and the second bit index was moved from the parity check set to the information set;
before the code rate of the second segment was increased, the third set of bit indices comprised a bit index in the information set on which an input bit value is placed, and the fourth set of bit indices comprised a bit index in the parity check set on which the same input bit value is also placed;
the bit indices comprise a plurality of third sets of bit indices that correspond to respective first segments of the encoded bit indices from which the number of encoded bits is reduced, and a plurality of fourth sets of bit indices that correspond to respective second segments of the encoded bit indices on which encoded bits are not reduced, the second set and the third sets of bit indices comprise a plurality of first bit indices on which the predetermined bit value is placed to reduce a code rate of each of the first segments of the encoded bit indices, and before the code rate of the second segments was increased, the third sets of bit indices further comprised respective bit indices in the information set on which respective input bit values are placed, and the fourth sets of bit indices comprised bit indices in the parity check set on which the same respective input bit values are also placed;
an order of placing the input bit values on the respective bit indices in the third sets and the information set is different from an order of placing the input bit values on the bit indices in the fourth sets and the parity check set;
the third set of bit indices comprises a plurality of unique parts, the fourth set of bit indices comprises a plurality of unique parts, and each part of the third set of bit indices is associated with a respective part of the fourth set of bit indices, the second set and each part of the third set of bit indices comprises a respective first bit index on which the predetermined bit value is placed to reduce a code rate of a respective part of the first segment of the encoded bit indices corresponding to each part of the third set of bit indices, and the first set and each part of the fourth set of bit indices comprises a respective second bit index on which a value of an input bit is placed to increase a code rate of a respective part of the second segment of the encoded bit indices corresponding to each part of the fourth set of bit indices;
the respective second bit indices in the first set and each part of the fourth set of bit indices comprise bit indices moved from the second set into the first set;
the first set of bit indices comprises an information set and a parity check set, and the respective second bit indices in the first set and each part of the fourth set of bit indices comprise bit indices moved from the parity check set into the information set;
the bit indices in each part of the third set of bit indices are in a different order relative to an order of the bit indices in the third set;
the bit indices in each part of the fourth set of bit indices are in a different order relative to an order of the bit indices in the fourth set;
the number of the encoded bits was reduced according to a rate matching operation;
an amount of rate reduction by which the code rate of the first segment of the encoded bit indices was reduced is based on one or more parameters;
the one or more parameters include any one or more of: a target code rate associated with the rate matching operation, the code rate of the second segment, a puncturing ratio associated with the rate matching operation, and a puncturing pattern associated with the rate matching operation;
each of a plurality of sets of the bit indices that respectively correspond to the plurality of unique segments of encoded bit indices of the encoded bits comprises consecutive bit indices in a sequential order of the bit indices, or consecutive bit indices in an interleaved order of the bit indices, the interleaved order of the bit indices corresponding to an interleaved order of the encoded bits for reducing the number of the encoded bits;
to reduce the code rate, a code rate reduction is code rate-dependent, puncture-dependent based on puncturing for rate matching, or jointly rate-and-puncture-dependent;
the apparatus or a component thereof such as an interface may be configured to receive (or for receiving), or programming may include instructions to receive (or for receiving) or to cause a processor to receive, the reduced number of encoded bits from a first communication device by a second communication device in a wireless communication network.

In another apparatus embodiment, an apparatus includes an interface and a decoder. The interface is for receiving a reduced number of encoded bits encoded by a polar code, and the decoder is coupled to the interface, for decoding the reduced number of encoded bits to obtain decoded input bits. Programming may include instructions to receive (or for receiving), or to cause a processor to receive, a reduced number of encoded bits encoded by a polar code, and to decode (or for decoding) the reduced number of encoded bits to obtain decoded input bits. In both of these examples, the polar code may comprise bit indices for placing values of input bits, with the bit indices comprising: a first set of bit indices of highest rank according to an ordered sequence, for placing the values of the input bits before encoding; a second set of bit indices of lower rank than the highest rank according to the ordered sequence, for a predetermined bit value; and a third set of bit indices corresponding to a first segment of encoded bit indices of the encoded bits. The order of rank is for reducing the number of the encoded bits. The second set and the third set of bit indices comprise a first bit index on which the predetermined bit value is to be placed to reduce a code rate of the first segment of the encoded bit indices, and the first segment is one of a plurality of unique segments of encoded bit indices of the encoded bits. Each segment of the encoded bit indices includes fewer than all of the encoded bit indices of all of the encoded bits.

The ordered sequence may have been obtained by modifying a base sequence that indicates the plurality of bit indices for the polar code in a base order of rank for placing the values of input bits for encoding by the polar code to obtain the number of encoded bits. The base order of rank is for outputting the number of the encoded bits.

Apparatus embodiments are not in any way restricted to single devices. A system, for example, may include a first communication device and a second communication device. The first communication device may be configured to encode (or for encoding) input bits by a polar code to obtain a number of encoded bits, to reduce (or for reducing) a number of the encoded bits on bit indices in a first segment of encoded bit indices of the encoded bits, and to transmit (or for transmitting) the reduced number of encoded bits. The second communication device may be configured to receive (or for receiving) the reduced number of the encoded bits from the first communication device, and to decode (or for decoding) the reduced number of the encoded bits to obtain decoded input bits. As in other embodiments, the polar code may comprise bit indices for placing values of the input bits before encoding, with the bit indices comprising: a first set of bit indices for the values of the input bits, a second set of bit indices for a predetermined bit value, and a third set of bit indices corresponding to the first segment. The first segment is one of a plurality of unique segments of the encoded bit indices of the encoded bits, and each segment of the encoded bit indices includes fewer than all encoded bit indices of all of the encoded bits. The second set and the third set of bit indices comprise a first bit index on which the predetermined bit value is placed to reduce a code rate of the first segment of the encoded bit indices.

The first communication device in a system may also or instead implement, provide, or support other encode-side or transmit-side features disclosed herein, and similarly the second communication device in a system may also or instead implement, provide, or support other decode-side or receive-side features disclosed herein.

More generally, other features disclosed herein may also or instead be provided in method, apparatus, and/or system embodiments.

Embodiments disclosed herein encompass various aspects of polar coding, including encoding and decoding.

Disclosed embodiments may provide a fundamental upgrade of polar codes, and may make polar codes applicable for a much wider set of scenarios.

For example, disclosed embodiments may be implemented as part of a channel coding scheme, and may thus be applicable wherever channel coding is used. This covers a very wide range of scenarios. The flexibility provided by embodiments disclosed herein may help make the associated channel coding scheme particularly suitable for wireless communications.

Possible product deployments, in or in conjunction with which embodiments may be implemented, include network devices such as base stations, access devices such as UEs, robots, sensors, cars, drones, and satellites. Service deployment examples include enhanced mobile broadband (eMBB), ultra-reliable low latency communications (URLLC), massive machine type communications (mMTC)/Internet of things (IoT), and vehicular and industry scenarios. Network deployment examples include 5G+, 6G, WiFi, non-terrestrial networks (NTNs), optical networks, distributed networks, and self-organized networks. These are illustrative and non-limiting examples, and other deployments, implementations, or applications are possible.

Potential advantages of embodiments disclosed herein include providing low-complexity and rate-compatible polar codes.

Partial rate reduction and related decoding approaches as disclosed herein, for example, may help better match the partial code rate of a punctured segment to its capacity, and/or otherwise help avoid catastrophic performance degradation. An adaptive partial rate reduction can determine the amount of rate reduction according to code rate and/or punctured length, for example, to potentially enable more accurate code rate reduction to achieve a wide range of rate compatibility. Piece-wise partial rate reduction as disclosed herein may also or instead help to achieve good performance in finer granularity.

As an example, for polar code with sequential puncturing, the SNR to achieve a target error rate may be significantly different from an approach that does not provide partial rate reduction.

To further summarize potential benefits, partial rate reduction may better match the partial code rate of a punctured segment to its capacity, which can help avoid catastrophic performance degradation. Adaptive partial rate reduction may provide for reducing partial code rate more accurately to achieve a wide range of rate compatibility. Piece-wise partial rate reduction may aid in fine-tuning piece-wise code rate in each segment to help achieve good performance in finer granularity.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
encoding input bits by a polar code to obtain a number of encoded bits, the polar code comprising bit indices for placing values of the input bits before encoding, the bit indices comprising: a first set of bit indices for the values of the input bits, a second set of bit indices for a predetermined bit value, and a third set of bit indices corresponding to a first segment of a plurality of unique segments of encoded bit indices of the encoded bits, each segment of the encoded bit indices including fewer than all encoded bit indices of all of the encoded bits, and the second set and the third set of bit indices comprising a first bit index on which the predetermined bit value is placed to reduce a code rate of the first segment of the encoded bit indices;
reducing a number of the encoded bits on the bit indices in the first segment of the encoded bit indices of the encoded bits, to obtain a reduced number of the encoded bits; and
outputting the reduced number of the encoded bits.

2. The method of claim 1, wherein the reducing comprises reducing the code rate of the first segment of the encoded bit indices by moving the first bit index from the first set of bit indices to the second set of bit indices.

3. The method of claim 1, wherein the bit indices further comprise a fourth set of bit indices corresponding to a second segment of the plurality of unique segments of encoded bit indices, the first set and the fourth set of bit indices comprising a second bit index on which a value of an input bit is placed to increase a code rate of the second segment of the encoded bit indices.

4. The method of claim 3, further comprising increasing the code rate of the second segment of the encoded bit indices by moving the second bit index from the second set of bit indices to the first set of bit indices.

5. The method of claim 3, wherein the first set of bit indices comprises an information set and a parity check set, and
wherein the method further comprises increasing the code rate of the second segment of the encoded bit indices by moving the second bit index from the parity check set to the information set.

6. A method comprising:
receiving a reduced number of encoded bits encoded by a polar code, the polar code comprising bit indices for placing values of input bits, the bit indices comprising: a first set of bit indices for the values of the input bits, a second set of bit indices for a predetermined bit value, and a third set of bit indices corresponding to a first segment of a plurality of unique segments of encoded bit indices of the encoded bits, each segment of the encoded bit indices including fewer than all encoded bit indices of all of the encoded bits, and the second set and the third set of bit indices comprising a first bit index on which the predetermined bit value is placed to reduce a code rate of the first segment of the encoded bit indices; and
decoding the reduced number of encoded bits to obtain decoded input bits.

7. The method of claim 6, wherein the first bit index was moved from the first set of bit indices to the second set of bit indices.

8. The method of claim 6, wherein the bit indices further comprise a fourth set of bit indices corresponding to a second segment of the plurality of unique segments of encoded bit indices, the first set and the fourth set of bit indices comprising a second bit index on which a value of an input bit is placed to increase a code rate of the second segment of the encoded bit indices.

9. The method of claim 8, wherein the second bit index was moved from the second set of bit indices into the first set of bit indices.

10. The method of claim 8, wherein the first set comprises an information set and a parity check set, and
wherein the second bit index was moved from the parity check set to the information set.

11. An apparatus comprising:
an encoder for encoding input bits by a polar code to obtain a number of encoded bits, the polar code comprising bit indices for placing values of the input bits before encoding, the bit indices comprising: a first set of bit indices for the values of the input bits, a second set of bit indices for a predetermined bit value, and a third set of bit indices corresponding to a first segment of a plurality of unique segments of encoded bit indices of the encoded bits, each segment of the encoded bit indices including fewer than all encoded bit indices of all of the encoded bits, and the second set and the third set of bit indices comprising a first bit index on which the predetermined bit value is placed to reduce a code rate of the first segment of the encoded bit indices;
a rate matching module coupled to the encoder, for reducing a number of the encoded bits on the bit indices in the first segment of the encoded bit indices of the encoded bits, to obtain a reduced number of the encoded bits; and
an interface coupled to the rate matching module, for outputting the reduced number of the encoded bits.

12. The apparatus of claim 11, wherein the rate matching module is configured to reduce the number of the encoded bits by reducing the code rate of the first segment of the encoded bit indices by moving the first bit index from the first set of bit indices to the second set of bit indices.

13. The apparatus of claim 11, wherein the bit indices further comprise a fourth set of bit indices corresponding to a second segment of the plurality of unique segments of encoded bit indices, the first set and the fourth set of bit indices comprising a second bit index on which a value of an input bit is placed to increase a code rate of the second segment of the encoded bit indices.

14. The apparatus of claim 13, the rate matching module being configured to increase the code rate of the second segment of the encoded bit indices by moving the second bit index from the second set of bit indices to the first set of bit indices.

15. The apparatus of claim 13, wherein the first set of bit indices comprises an information set and a parity check set,
wherein the rate matching module being configured to increase the code rate of the second segment of the encoded bit indices by moving the second bit index from the parity check set to the information set.

16. An apparatus comprising:
an interface for receiving a reduced number of encoded bits encoded by a polar code, the polar code comprising bit indices for placing values of input bits, the bit indices comprising: a first set of bit indices for the values of the input bits, a second set of bit indices for a predetermined bit value, and a third set of bit indices corresponding to a first segment of a plurality of unique segments of encoded bit indices of the encoded bits, each segment of the encoded bit indices including fewer than all encoded bit indices of all of the encoded bits, and the second set and the third set of bit indices comprising a first bit index on which the predetermined bit value is placed to reduce a code rate of the first segment of the encoded bit indices; and
a decoder coupled to the interface, for decoding the reduced number of encoded bits to obtain decoded input bits.

17. The apparatus of claim 16, wherein the first bit index was moved from the first set of bit indices to the second set of bit indices.

18. The apparatus of claim 16, wherein the bit indices further comprise a fourth set of bit indices corresponding to a second segment of the plurality of unique segments of encoded bit indices, the first set and the fourth set of bit indices comprising a second bit index on which a value of an input bit is placed to increase a code rate of the second segment of the encoded bit indices.

19. The apparatus of claim 18, wherein the second bit index was moved from the second set of bit indices into the first set of bit indices.

20. The apparatus of claim 18, wherein the first set comprises an information set and a parity check set,
wherein the second bit index was moved from the parity check set to the information set.
